(19) United States
(12) Patent Application Publication
(10) Pub. No.: US 2025/0102941 A1
(43) Pub. Date: Mar. 27, 2025

(54) ELECTROSTATIC-IMAGE DEVELOPING TONER SET, ELECTROSTATIC-IMAGE DEVELOPER SET, TONER CARTRIDGE SET, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Reina MURANO, Kanagawa (JP); Masahiro TAKAYAMA, Kanagawa (JP); Yuka ISHIHARA, Kanagawa (JP); Yukiko KAMIJO, Kanagawa (JP); Masashi IKEDA, Kanagawa (JP); Koji FUNABA, Kanagawa (JP); Yuko HIRANO, Kanagawa (JP)

(73) Assignee: FUJIFILM Business Innovation Corp., Tokyo (JP)

(21) Appl. No.: 18/826,417

(22) Filed: Sep. 6, 2024

(30) Foreign Application Priority Data
Sep. 22, 2023 (JP) 2023-159103

(51) Int. Cl. G03G 9/087; G03G 9/09; G03G 15/01

(52) U.S. Cl. CPC G03G 9/08755; G03G 9/08704; G03G 9/09; G03G 15/0121; G03G 2215/2074

(57) ABSTRACT

An electrostatic-image developing toner set includes a white toner including white toner particles including a polyester resin and a white colorant, and a colored toner other than a white toner, the colored toner including colored toner particles including a vinyl resin, a polyester resin, and a colored colorant, in which the mass ratio C of the polyester resin included in the colored toner particles to the vinyl resin included in the colored toner particles is 0.7 or more and 10 or less, and when the cross section of the colored toner particles is observed, the area fraction of the polyester resin present in a surface layer region of the colored toner particles, the surface layer region corresponding to 15% of the area of the cross section of the colored toner particles, is 60% or more and 100% or less.

### CROSS-REFERENCE TO RELATED APPLICATIONS

This application is based on and claims priority under 35 USC 119 from Japanese Patent Application No. 2023-159103 filed Sep. 22, 2023.

### BACKGROUND

### (i) Technical Field

The present disclosure relates to an electrostatic-image developing toner set, an electrostatic-image developer set, a toner cartridge set, a process cartridge, an image forming apparatus, and an image forming method.

### (ii) Related Art

A technique of using a white toner to form a colored image on a colored or transparent recording medium in the formation of electrophotographic images is known.

For example, Japanese Patent No. 7163574 proposes an image forming method including a step of transferring and fixing a white toner and at least one colored toner to a recording medium simultaneously in order to form an image, the colored toner including toner base particles, the toner base particles including a plurality of protrusions arranged at least on the surfaces thereof.

### SUMMARY

Aspects of non-limiting embodiments of the present disclosure relate to an electrostatic-image developing toner set that includes a white toner including white toner particles including a polyester resin and a white colorant and a colored toner other than a white toner, the colored toner including colored toner particles including a vinyl resin, a polyester resin, and a colored colorant, which may enhance the color forming property of an image including a white image and a colored image formed thereon and reduce the detachment of the colored image, compared with the case where the mass ratio C of the polyester resin included in the colored toner particles to the vinyl resin included in the colored toner particles is less than 0.7 or more than 10 or, when a cross section of the colored toner particles is observed, the area fraction of the polyester resin present in a surface layer region of the colored toner particles, the surface layer region corresponding to 15% of the area of the cross section of the colored toner particles, is less than 60%.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrostatic-image developing toner set including a white toner including white toner particles including a polyester resin and a white colorant; and a colored toner other than a white toner, the colored toner including colored toner particles including a vinyl resin, a polyester resin, and a colored colorant, wherein a mass ratio C of the polyester resin included in the colored toner particles to the vinyl resin included in the colored toner particles is 0.7 or more and 10 or less, and when a cross section of the colored toner particles is observed, an area fraction of the polyester resin present in a surface layer region of the colored toner particles, the surface layer region corresponding to 15% of an area of the cross section of the colored toner particles, is 60% or more and 100% or less.

### BRIEF DESCRIPTION OF THE DRAWINGS

Exemplary embodiments of the present disclosure will be described in detail based on the following figures, wherein:

FIG. 1 is a schematic diagram illustrating an example of an image forming apparatus according to an exemplary embodiment;

FIG. 2 is a schematic diagram illustrating an example of a process cartridge according to an exemplary embodiment; and

FIG. 3 is a schematic diagram illustrating an example of a screw extruder used in knead pulverization.

### DETAILED DESCRIPTION

Exemplary embodiments of the present disclosure are described below. It should be noted that the following description and Examples are illustrative of the exemplary embodiments but not restrictive of the scope of the present disclosure.

In the exemplary embodiments, a numerical range expressed using “to” means the range that includes the values described before and after “to” as the minimum and maximum values, respectively.

In the exemplary embodiments, when numerical ranges are described in a stepwise manner, the upper or lower limit of a numerical range may be replaced with the upper or lower limit of another numerical range, respectively. In the exemplary embodiments, the upper or lower limit of a numerical range may also be replaced with a value described in Examples below.

In the exemplary embodiments, the term “step” refers not only to an individual step but also to a step that is not distinguishable from other steps but achieves the intended purpose of the step.

In the exemplary embodiments, when an exemplary embodiment is described with reference to a drawing, the structure of the exemplary embodiment is not limited to the structure illustrated in the drawing. The sizes of the members illustrated in the attached drawing are conceptual and do not limit the relative relationship among the sizes of the members.

Each of the components described in the exemplary embodiments may include a plurality of types of substances that correspond to the component. In the exemplary embodiments, in the case where a composition includes a plurality of substances that correspond to a component of the composition, the content of the component in the composition is the total content of the substances in the composition unless otherwise specified.

The term “(meth)acryl” used in the exemplary embodiments refers to both “acryl” and “methacryl”.

In the exemplary embodiments, an electrostatic-image developing white toner may be referred to simply as “white toner”, an electrostatic-image developing colored toner may be referred to simply as “colored toner”, an electrostatic-image white developer may be referred to simply as “white developer”, and an electrostatic-image colored developer may be referred to simply as “colored developer”.

In the exemplary embodiments, an electrostatic-image developing toner set may be referred to simply as “toner set”, and an electrostatic-image developer set may be referred to simply as “developer set”.

### Electrostatic-Image Developing Toner Set

A toner set according to an exemplary embodiment includes a white toner including white toner particles including a polyester resin and a white colorant, and a colored toner other than a white toner, the colored toner including colored toner particles including a vinyl resin, a polyester resin, and a colored colorant.

The mass ratio C of the polyester resin included in the colored toner particles to the vinyl resin included in the colored toner particles is 0.7 or more and 10 or less.

When a cross section of the colored toner particles is observed, an area fraction of the polyester resin present in a surface layer region of the colored toner particles, the surface layer region corresponding to 15% of an area of the cross section of the colored toner particles, is 60% or more and 100% or less.

The toner set according to this exemplary embodiment, which has the above-described structure, may enhance the color forming property of an image including a white image and a colored image formed thereon and reduce the detachment of the colored image. The reasons are considered as follows.

For forming images on colored sheets, such as black paper, films, such as a beverage label, and other recording media, for example, a white image is formed as a ground and a colored image is formed on the white image in order to enhance the color forming property of the colored image.

A combination of white toner particles that include a polyester resin as a binder resin and colored toner particles that include a vinyl resin (e.g., a styrene-acrylic resin) and a polyester resin as binder resins is known. This is because, in such a case, the dispersibility of the white colorant in the white toner may be enhanced, while the chargeability and fixability of the colored toner are both enhanced.

For reducing the likelihood of the colored image detaching due to rubbing or the like, it is suitable that the white and colored images be fixed to each other with high adhesiveness.

When white toner particles that include a polyester resin as a binder resin are used in combination with colored toner particles that include a vinyl resin (e.g., a styrene-acrylic resin) and a polyester resin as binder resins, the components of the white and colored toner particles are unlikely to mix with each other during fixing and, consequently, the adhesiveness of the colored image to the white image may become degraded. Accordingly, when the image is rubbed, the detachment of the colored image may occur.

On the other hand, if the components of the white and colored toner particles are excessively mixed with each other during fixing, color mixing may occur as a result of the components of the white and colored toner particles being excessively mixed with each other. This degrades the color forming property of the colored image.

In particular, since recording media and toners are cooled in a low-temperature environment, such as winter months, the affinity between the white and colored toner particles becomes degraded during fixing. This reduces the likelihood of the components of the toners mixing with each other and consequently increases the detachment of the colored image. In a high-temperature environment, such as summer months, since the temperatures of recording media and toners are increased as a result of continuous image formation, the affinity between the white and colored toner particles becomes enhanced. This increases the likelihood of the components of the toners excessively mixing with each other and consequently increases the degradation of the color forming property of the colored image.

Accordingly, in the toner set according to this exemplary embodiment, the mass ratio C of the polyester resin included in the colored toner particles to the vinyl resin included in the colored toner particles is limited to 0.7 or more and 10 or less.

The colored toner particles, which include a vinyl resin and a polyester resin as binder resins at the mass ratio C, include a vinyl resin, which has low fixability, and a polyester resin, which may cause mixing of the components of the white and colored toners, in adequate amounts.

Consequently, during fixing, the affinity between the white and colored toner particles is at an adequate level which allows the components of the white and colored toner particles to be mixed with each other in an adequate manner. This enables a sufficient degree of adhesiveness between the white and colored images to be achieved.

In addition, since the white and colored toner particles do not mix with each other to an excessive degree, not only the excessive mixing of the components but also the degradation of the dispersibility of the white colorant in the white image may be limited. Consequently, the scattering property of the white image may be enhanced while the mixing of the white colorant and the colored colorant is limited and, as a result, the degradation of the color forming property of the colored image may be limited.

Moreover, the area fraction of the polyester resin present in a surface layer region of the colored toner particles, the surface layer region corresponding to 15% of an area of the cross section of the colored toner particles, is limited to 60% or more and 100% or less. That is, the proportion of the polyester resin in the surface layer region of the colored toner particles is increased.

As a result, during fixing, the surface layer region of the colored toner particles becomes miscible with the white toner particles, which include a polyester resin, while the inside region of the colored toner particles is immiscible. Consequently, the mixing of the components of the white and colored toner particles may be limited while the adhesiveness between the white and colored images is maintained and, as a result, the degradation of the color forming property of the colored image may be also limited.

For the above reasons, it is considered that the toner set according to this exemplary embodiment may enhance the color forming property of an image including a white image and a colored image formed thereon and reduce the detachment of the colored image.

Details of the toner set according to this exemplary embodiment are described below.

### Resin Contents in White and Colored Toners

### Mass Ratio C

The mass ratio C of the polyester resin included in the colored toner particles to the vinyl resin included in the colored toner particles is 0.7 or more and 10 or less.

If the mass ratio C is less than 0.7, the proportion of the vinyl resin in the colored toner particles is excessively increased. In such a case, the miscibility between the white and colored toner particles is reduced during fixing and the adhesiveness between the white and colored images may become degraded accordingly. This increases the detachment of the colored image.

If the mass ratio C is more than 10, the proportion of the polyester resin in the colored toner particles is excessively increased. In such a case, the polyester resin included in the colored toner particles mixes with the polyester resin included in the white toner particles to an excessive degree during fixing and, consequently, the white and colored colorants may be mixed with each other disadvantageously. Moreover, the dispersibility of the white pigment may become degraded, which results in the degradation of the color forming property of the colored image.

In order to reduce the detachment of the colored image and enhance the color forming property of the colored image, the mass ratio C is preferably 2 or more and 6 or less and is more preferably 3 or more and 5 or less.

### Relationship Between Mass Ratios C and W

In the case where the white toner particles include a vinyl resin, the relationship between the mass ratio W of the polyester resin included in the white toner particles to the vinyl resin included in the white toner particles and the mass ratio C of the polyester resin included in the colored toner particles to the vinyl resin included in the colored toner preferably satisfies −0.6≤W-C≤5.6.

The relationship W-C between the mass ratios W and C more preferably satisfies 0≤ W-C≤4 and further preferably satisfies 1≤W-C≤3.

When the relationship W-C between the mass ratios W and C falls within the above range, the relationship between the ratios between the vinyl resin and the polyester resin in the white and colored toner particles becomes adequate. In such a case, the polyester resins included in the white and colored toner particles may be mixed with each other in an adequate manner during fixing and, consequently, the adhesiveness between the white and colored images may be enhanced to a sufficient degree. Thus, the detachment of the colored image may be readily reduced while the degradation of the color forming property of the colored image is limited.

### Measurement of Resin Contents in Toner Particles

The contents of the resins in the toner particles (i.e., the white and colored toner particles) are determined in the following manner.

The resins included in the toner particles are identified using nuclear magnetic resonance, infrared spectroscopy, and pyrolysis-gas chromatography-mass spectrometry which are known in the related art.

The contents of the resins in the toner particles are determined by performing centrifugation and measuring a 1H-NMR spectrum with a nuclei magnetic resonance device. The specific method is as described below.

Toner particles (or a toner) the mass of which has been measured are dissolved in toluene. The resulting solution is centrifugated in order to separate resin and non-resin components from each other.

The solution in which the resin component is dissolved is collected, and the solvent is removed by drying in order to obtain the resin component (i.e., the solid component). The mass ratio between the resin component and the non-resin solid component is calculated on the basis of the mass of the resin component.

In 0.7 mL of a chloroform-d solution, 10 mg of the resin component is dissolved. Tetramethyl silane (TMS), which serves as a reference material, is added to the solution at a concentration of 0.05% by volume. This solution is used as a measurement sample.

The 1H-NMR spectrum of the measurement sample is measured using a nuclei magnetic resonance device “JNM-AL400” produced by JEOL Ltd. The measurement conditions are as follows: reference material: tetramethyl silane (TMS), temperature: 25° C., the number of integrations: 128.

The chemical shifts and integration ratios are determined by analysis of the 1H-NMR spectrum. The molar proportions of the monomers constituting the resin are determined on the basis of the chemical shifts and integration ratios.

Finally, the molar proportions of the monomers are multiplied by the molecular weights of the polymer segment units in order to make a conversion from molar ratio to mass ratio. The contents of the resins in the toner particles are determined on the basis of the mass ratio.

### Area Fraction of Polyester Resin Present in Surface Layer Region of Colored Toner Particles

When a cross section of the colored toner particles is observed, the area fraction of the polyester resin present in a surface layer region of the colored toner particles, the surface layer region corresponding to 15% of the area of the cross section of the colored toner particles, is 60% or more and 100% or less, is preferably 78% or more and 100% or less, and is more preferably 90% or more and 100% or less.

If the area fraction of the polyester resin present in the surface layer region is less than 60%, the likelihood of the inside region of the colored toner particles mixing with the white toner particles during fixing is also increased and, consequently, the components of the white and colored toner particles may mix with each other to an excessive degree. This degrades the color forming property of the colored image.

The area fraction of the polyester resin present in the surface layer region may be adjusted by, for example, in the method for producing toner particles using emulsification aggregation which is described below, using only polyester resin particles as second resin particles for forming the surface layer region of the colored toner particles or by increasing the amount of the polyester resin particles used.

### Area Fraction of Polyester Resin Present in Inside Region of Colored Toner Particles Closer to Center Than Surface Layer Region

When a cross section of the colored toner particles is observed, the area fraction of the polyester resin present in an inside region of the colored toner particles, the inside region being closer to the center than the surface layer region of the colored toner particles, is preferably 15% or more and 45% or less, is more preferably 20% or more and 40% or less, and is further preferably 25% or more and 35% or less.

When the area fraction of the polyester resin present in the inside region is 15% or more and 45% or less, the likelihood of the inside region of the colored toner particles mixing with the white toner particles during fixing is also reduced and, consequently, the components of the white and colored toner particles are unlikely to mix with each other to an excessive degree. This readily limits the degradation of the color forming property of the colored image. In addition, the detachment of the colored image may also be readily reduced.

The area fraction of the polyester resin present in the inside region may be adjusted by, for example, in the method for producing toner particles using emulsification aggregation which is described below, using only vinyl resin particles as first resin particles for forming the inside region of the colored toner particles or by increasing the amount of the vinyl resin particles used.

### Ratio X of Perimeter to Equivalent-Circle Perimeter of Colored Toner Particles (Perimeter/Equivalent-Circle Perimeter)

When a cross section of the colored toner particles is observed, the ratio X (perimeter/equivalent-circle perimeter) of the perimeter of the colored toner particles to the equivalent-circle perimeter of the colored toner particles is preferably 1.14 or less, is more preferably 1.12 or less, and is further preferably 1.10 or less.

When the ratio X is 1.14 or less, the colored toner particles have small surface irregularities, that is, flat and smooth surfaces. In such a case, when the colored and white toner particles are mixed with each other during fixing, the adhesiveness of the colored image to the white image may be enhanced. Consequently, the detachment of the image may be readily reduced.

The ratio X may be adjusted by, for example, in the emulsification aggregation method described below, increasing the amount of surfactant used together with the second resin particles that are to be aggregated to the first aggregated particles, or by increasing the temperature at which heating is performed in the fusion-coalescence step and the amount of time during which the heating is performed.

### Method for Observing Cross Section of Colored Toner Particles and Method for Determining Area Fractions of Components and Ratio X

The observation of a cross section of the colored toner particles is done by observing an STEM image taken with an ultrahigh-resolution field emission scanning electron microscope (FE-SEM). A specific method is as described below.

The colored toner particles (or the colored toner) is buried in an epoxy resin, and the epoxy resin is then solidified. The resulting solid is sliced into a thin-piece sample having a thickness of 80 nm or more and 130 nm or less with an ultramicrotome “Ultracut-UCT” produced by Leica.

The thin-piece sample is stained with ruthenium tetroxide for 3 hours in a desiccator kept at 30° C. The stained thin-piece sample is inspected with an ultrahigh-resolution field emission scanning electron microscope (FE-SEM) “S-4800” produced by Hitachi High-Tech Corporation for the cross section of the colored toner particles in a transmission image mode (acceleration voltage: 30 kV, magnification: 20,000x) to obtain an STEM image.

In the observation of the cross section of the colored toner, colored toner particles the diameter (i.e., longer-axis length) of which in the cross section is 85% or more of the number average particle size are selected. Note that the expression “the diameter of a colored toner particle in the cross section” refers to the maximum length of the straight line that connects two points located on the contour line of the cross section of the colored toner particle (i.e., the longer-axis length of the colored toner particle).

In the SEM image, the vinyl resin and the polyester resin included in the colored toner particles are distinguished from each other on the basis of shape and contrast.

The larger the amount of double-bond portions included in a resin, the higher the degree of staining of the resin with ruthenium tetroxide.

Therefore, a region (i.e., domain) in which a vinyl resin is present is stained more strongly than a region (i.e., domain) in which a polyester resin is present. The regions (i.e., domains) can be distinguished from one another on the basis of shade. A region (i.e., domain) in which a release agent is present is stained most weakly.

Note that shade is adjusted such that a region (i.e., domain) in which a vinyl resin is present appears as dark gray, a region (i.e., domain) in which a polyester resin is present appears as light gray, and a region (i.e., domain) in which a release agent is present appears as white.

In a cross section of the colored toner particles in the SEM image, a region surrounded by the outline of the cross section of a colored toner particle and a virtual line that extends along the outline of the cross section of the colored toner particle and located closer to the center than the outline, the region corresponding to 15% of the area of the cross section of the colored toner particle, is defined as a surface layer region. The area of the polyester resin present in the surface layer region is measured, and the ratio of the area of the polyester resin present in the surface layer region to the area of the surface layer region is calculated. The above operation is done for 100 colored toner particles, and the arithmetic average of the proportion [%] of the area of the polyester resin present in the surface layer region is calculated.

In the cross section of a colored toner particle in the SEM image, a region other than the surface layer region of the colored toner particle is defined as the inside region of the colored toner particle. The area of the polyester resin present in the inside region is measured, and the ratio of the area of the polyester resin present in the inside region to the area of the inside region is calculated. The above operation is done for 100 colored toner particles, and the arithmetic average of the proportion [%] of the area of the polyester resin present in the inside region is calculated.

In a cross section of the colored toner particles in the SEM image, the area of a cross section of a colored toner particle is measured, and the equivalent-circle perimeter thereof is calculated on the basis of the equivalent circle diameter calculated from the area. The perimeter (i.e., the actual length of the outline) of the cross section of the colored toner particle is also measured. The ratio X (perimeter/equivalent-circle perimeter) is calculated. The above operation is done for 100 colored toner particles, and the arithmetic average of the ratios X is calculated.

Note that the area and perimeter of the cross section of each colored toner particle and the area of the resins in the SEM image are determined by analyzing the image with an image processing and analysis system “LUZEX AP” produced by NIRECO CORPORATION.

### Net Intensity of Sulfur Element in Colored Toner Particles

The Net intensity of the sulfur element included in the colored toner particles, the Net intensity being determined by X-ray fluorescence spectrometry, is preferably 3.0 kcps or more and 6.0 kcps or less, is more preferably 3.8 kcps or more and 5.7 kcps or less, and is further preferably 4.2 kcps or more and 5.2 kcps or less.

When the Net intensity of the sulfur element included in the colored toner particles falls within the above range, an adequate amount of sulfur element, which has a high electronegativity, is present in the colored toner particles. In such a case, the compatibility between the resin components during granulation is enhanced and, consequently, the scratch resistance of the colored image is enhanced. This may readily reduce the detachment of the image.

In particular, in the case where the colored toner particles are core-shell toner particles, the compatibility between the core and the shell is enhanced and, consequently, the scratch resistance of the colored image is enhanced. This may readily reduce the detachment of the image.

Examples of the source of supply of the sulfur element include additives, such as a surfactant and a coagulant, which contain sulfur. Specific examples of the source of supply of the sulfur element include sulfuric acid ester salt-based anionic surfactants, sulfonic acid salt-based anionic surfactants, and metal salts, such as aluminum sulfate.

The Net intensity of the sulfur element included in the colored toner particles which is determined by X-ray fluorescence spectrometry is measured by the following method.

With a compression molding machine, 0.12 g of the colored toner particles (i.e., the colored toner) are compressed at a load of 6 t for 60 seconds to form a disk having a diameter of 50 mm and a thickness of 2 mm. Using the disk as a sample, an elemental analysis is conducted with an X-ray fluorescence spectrometry apparatus “XRF-1500” produced by Shimadzu Corporation at a tube voltage of 40 kV and a tube current of 70 mA in order to determine the Net intensity of the sulfur element.

### Structures of White and Colored Toners

The components of the toners (i.e., the white and colored toners) included in the toner set according to this exemplary embodiment are described below.

The toners according to this exemplary embodiment include toner particles and may further include an external additive.

Note that the terms “colored toner”, “colored toner particles”, “colored colorant”, and “colored image” used herein refer to a toner, toner particles, a colorant, and an image that have a color other than white, respectively. For example, examples of the colored toner include color toners, such as yellow (Y), magenta (M), and cyan (C) toners and a black (K) toner.

A plurality of toners having different colors may be used in combination as a colored toner. For example, yellow, magenta, cyan, and black toners may be used in combination as a colored toner, which may form a toner set together with a white toner. In such a case, at least one of the colored toners may satisfy the above-described conditions. Alternatively, all of the colored toners used in combination may satisfy the above-described conditions.

### Toner Particles

The white toner particles include a polyester resin that serves as a binder resin and a white colorant. The white toner particles may include a polyester resin and a vinyl resin that serve as binder resins.

The colored toner particles include a polyester resin and a vinyl resin that serve as binder resins and a colored colorant.

The toner particles (i.e., the white and colored toner particles) may include a release agent and other additives.

Each of the components is described below.

### Binder Resin

The polyester resin is described below.

Examples of the polyester resin include the amorphous polyester resins known in the related art. As a polyester resin, an amorphous polyester resin may be used in combination with a crystalline polyester resin. In such a case, the content of the crystalline polyester resin may be 2% by mass or more and 40% by mass or less and is preferably 2% by mass or more and 20% by mass or less of the total amount of all the binder resins.

The term “crystalline” used herein for resins refers to a property of exhibiting a distinct endothermic peak instead of a step-like endothermic change in DSC, that is, specifically, a property of exhibiting an endothermic peak with a half-width of 10° C. or less at a heating rate of 10° C./min.

The term “amorphous” used herein for resins refers to a property of having a half-width of more than 10° C., a property of exhibiting a step-like endothermic change, or a property of not exhibiting a distinct endothermic peak.

### Amorphous Polyester Resin

Examples of the amorphous polyester resin include condensation polymers of a polyvalent carboxylic acid and a polyhydric alcohol. The amorphous polyester resin may be a commercially available one or a synthesized one.

Examples of the polyvalent carboxylic acid include aliphatic dicarboxylic acids, such as oxalic acid, malonic acid, maleic acid, fumaric acid, citraconic acid, itaconic acid, glutaconic acid, succinic acid, alkenyl succinic acid, adipic acid, and sebacic acid; alicyclic dicarboxylic acids, such as cyclohexanedicarboxylic acid; aromatic dicarboxylic acids, such as terephthalic acid, isophthalic acid, phthalic acid, and naphthalenedicarboxylic acid; anhydrides of these dicarboxylic acids; and lower (e.g., 1 to 5 carbon atoms) alkyl esters of these dicarboxylic acids. Among these polyvalent carboxylic acids, aromatic dicarboxylic acids may be used.

Trivalent or higher carboxylic acids having a crosslinked structure or a branched structure may be used as a polyvalent carboxylic acid in combination with the dicarboxylic acids. Examples of the trivalent or higher carboxylic acids include trimellitic acid, pyromellitic acid, anhydrides of these carboxylic acids, and lower (e.g., 1 to 5 carbon atoms) alkyl esters of these carboxylic acids.

The above polyvalent carboxylic acids may be used alone or in combination of two or more.

Examples of the polyhydric alcohol include aliphatic diols, such as ethylene glycol, diethylene glycol, triethylene glycol, propylene glycol, butanediol, hexanediol, and neopentyl glycol; alicyclic diols, such as cyclohexanediol, cyclohexanedimethanol, and hydrogenated bisphenol A; and aromatic diols, such as bisphenol A-ethylene oxide adduct and bisphenol A-propylene oxide adduct. Among these polyhydric alcohols, for example, aromatic diols and alicyclic diols may be used. In particular, aromatic diols may be used.

Trihydric or higher alcohols having a crosslinked structure or a branched structure may be used as a polyhydric alcohol in combination with the diols. Examples of the trihydric or higher alcohols include glycerin, trimethylolpropane, and pentaerythritol.

The above polyhydric alcohols may be used alone or in combination of two or more.

The glass transition temperature Tg of the amorphous polyester resin is preferably 50° C. or more and 80° C. or less and is more preferably 50° C. or more and 65° C. or less.

The glass transition temperature of a resin is determined from a differential scanning calorimetry (DSC) curve obtained by DSC. More specifically, the glass transition temperature of a resin is determined from the “extrapolated glass-transition-starting temperature” according to a method for determining glass transition temperature which is described in JIS K 7121:1987 “Testing Methods for Transition Temperatures of Plastics”.

The weight average molecular weight Mw of the amorphous polyester resin is preferably 5,000 or more and 1,000,000 or less and is more preferably 7,000 or more and 500,000 or less.

The number average molecular weight Mn of the amorphous polyester resin may be 2,000 or more and 100,000 or less.

The molecular weight distribution index Mw/Mn of the amorphous polyester resin is preferably 1.5 or more and 100 or less and is more preferably 2 or more and 60 or less.

The weight average molecular weight and number average molecular weight of a resin are determined by gel permeation chromatography (GPC). Specifically, the molecular weights of a resin are determined by GPC using a “HLC-8120GPC” produced by Tosoh Corporation as measuring equipment, a column “TSKgel SuperHM-M (15 cm)” produced by Tosoh Corporation, and a THF solvent. The weight average molecular weight and number average molecular weight of the resin are determined on the basis of the results of the measurement using a molecular-weight calibration curve based on monodisperse polystyrene standard samples.

The amorphous polyester resin may be produced by any suitable production method known in the related art. Specifically, the amorphous polyester resin may be produced by, for example, a method in which polymerization is performed at 180° C. or more and 230° C. or less, the pressure inside the reaction system is reduced as needed, and water and alcohols that are generated by condensation are removed.

In the case where the raw materials, that is, the monomers, are not dissolved in or miscible with each other at the reaction temperature, a solvent having a high boiling point may be used as a dissolution adjuvant in order to dissolve the raw materials. In such a case, the condensation polymerization reaction is performed while the dissolution adjuvant is distilled away. In the case where a monomer having low miscibility is present, a condensation reaction of the monomers with an acid or alcohol that is to undergo a polycondensation reaction with the monomers may be performed in advance and subsequently polycondensation of the resulting polymers with the other components may be performed.

### Crystalline Polyester Resin

Examples of the crystalline polyester resin include condensation polymers of a polyvalent carboxylic acid and a polyhydric alcohol. The crystalline polyester resin may be commercially available one or a synthesized one.

In order to increase ease of forming a crystal structure, a condensation polymer prepared from linear aliphatic polymerizable monomers may be used as a crystalline polyester resin instead of a condensation polymer prepared from polymerizable monomers having an aromatic ring.

Examples of the polyvalent carboxylic acid include aliphatic dicarboxylic acids, such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; aromatic dicarboxylic acids, such as dibasic acids (e.g., phthalic acid, isophthalic acid, terephthalic acid, and naphthalene-2,6-dicarboxylic acid); anhydrides of these dicarboxylic acids; and lower (e.g., 1 to 5 carbon atoms) alkyl esters of these dicarboxylic acids.

Trivalent or higher carboxylic acids having a crosslinked structure or a branched structure may be used as a polyvalent carboxylic acid in combination with the dicarboxylic acids. Examples of the trivalent carboxylic acids include aromatic carboxylic acids, such as 1,2,3-benzenetricarboxylic acid, 1,2,4-benzenetricarboxylic acid, and 1,2,4-naphthalenetricarboxylic acid; anhydrides of these tricarboxylic acids; and lower (e.g., 1 to 5 carbon atoms) alkyl esters of these tricarboxylic acids.

Dicarboxylic acids including a sulfonic group and dicarboxylic acids including an ethylenic double bond may be used as a polyvalent carboxylic acid in combination with the above dicarboxylic acids.

The above polyvalent carboxylic acids may be used alone or in combination of two or more.

Examples of the polyhydric alcohol include aliphatic diols, such as linear aliphatic diols including a backbone having 7 to 20 carbon atoms. Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these aliphatic diols, 1,8-octanediol, 1,9-nonanediol, and 1,10-decanediol may be used.

Trihydric or higher alcohols having a crosslinked structure or a branched structure may be used as a polyhydric alcohol in combination with the above diols. Examples of the trihydric or higher alcohols include glycerin, trimethylolethane, trimethylolpropane, and pentaerythritol.

The above polyhydric alcohols may be used alone or in combination of two or more.

The content of the aliphatic diols in the polyhydric alcohol may be 80 mol % or more and is preferably 90 mol % or more.

The melting temperature of the crystalline polyester resin is preferably 50° C. or more and 100° C. or less, is more preferably 55° C. or more and 90° C. or less, and is further preferably 60° C. or more and 85° C. or less.

The above melting temperature is determined from the “melting peak temperature” according to a method for determining melting temperature which is described in JIS K 7121:1987 “Testing Methods for Transition Temperatures of Plastics” using a differential scanning calorimetry (DSC) curve obtained by DSC.

The weight average molecular weight Mw of the crystalline polyester resin may be 6,000 or more and 35,000 or less.

The crystalline polyester resin may be produced by a production method known in the related art as in, for example, the preparation of the amorphous polyester above.

The vinyl resin is described below.

Examples of the vinyl resin include vinyl resins that are homopolymers of the following monomers or copolymers of two or more monomers selected from the following monomers: styrenes, such as styrene, para-chlorostyrene, and α-methylstyrene; (meth)acrylates, such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; ethylenically unsaturated nitriles, such as acrylonitrile and methacrylonitrile; vinyl ethers, such as vinyl methyl ether and vinyl isobutyl ether; vinyl ketones, such as vinyl methyl ketone, vinyl ethyl ketone, and vinyl isopropenyl ketone; and olefins, such as ethylene, propylene, and butadiene.

The above vinyl resins may be used alone or in combination of two or more.

The vinyl resin may be a styrene-acrylic resin in order to enhance the environmental stability of charging of the toner.

A styrene-acrylic resin is a copolymer produced by the copolymerization of at least a styrene-based monomer (i.e., a monomer having a styrene skeleton) with a (meth)acrylic acid-based monomer (i.e., a monomer having a (meth)acryloyl group and preferably having a (meth)acryloyloxy group). Examples of the styrene-acrylic resin include a copolymer of a monomer selected from the styrenes with a monomer selected from the above-described(meth)acrylic acid esters. The acrylic resin portion of the styrene-acrylic resin is a structural unit produced by polymerization of an acryl-based monomer, a methacryl-based monomer, or both acryl-based monomer and methacryl-based monomer. The term “(meth)acryl” used herein refers to both “acryl” and “methacryl”.

Specific examples of the styrene-based monomer include styrene, alkyl-substituted styrenes (e.g., α-methylstyrene, 2-methylstyrene, 3-methylstyrene, 4-methylstyrene, 2-ethylstyrene, 3-ethylstyrene, and 4-ethylstyrene), halogen-substituted styrenes (e.g., 2-chlorostyrene, 3-chlorostyrene, and 4-chlorostyrene), and vinylnaphthalene. These styrene-based monomers may be used alone or in combination of two or more.

Among these styrene-based monomers, styrene may be used from the viewpoints of reactivity, ease of controlling a reaction, and availability.

Specific examples of the (meth)acrylic acid-based monomer include (meth)acrylic acid and (meth)acrylic acid esters. Examples of the (meth)acrylic acid esters include (meth)acrylic acid alkyl esters (e.g., methyl (meth)acrylate, ethyl(meth)acrylate, n-propyl(meth)acrylate, n-butyl(meth)acrylate, n-pentyl(meth)acrylate, n-hexyl acrylate, n-heptyl(meth)acrylate, n-octyl(meth)acrylate, n-decyl(meth)acrylate, n-dodecyl(meth)acrylate, n-lauryl(meth)acrylate, n-tetradecyl(meth)acrylate, n-hexadecyl(meth)acrylate, n-octadecyl(meth)acrylate, isopropyl(meth)acrylate, isobutyl(meth)acrylate, t-butyl(meth)acrylate, isopentyl(meth)acrylate, amyl(meth)acrylate, neopentyl(meth)acrylate, isohexyl(meth)acrylate, isoheptyl(meth)acrylate, isooctyl(meth)acrylate, 2-ethylhexyl(meth)acrylate, cyclohexyl(meth)acrylate, and t-butylcyclohexyl(meth)acrylate); (meth)acrylic acid aryl esters (e.g., phenyl(meth)acrylate, biphenyl(meth)acrylate, diphenylethyl(meth)acrylate, t-butylphenyl(meth)acrylate, and terphenyl(meth)acrylate); dimethylaminoethyl(meth)acrylate; diethylaminoethyl(meth)acrylate; methoxyethyl(meth)acrylate; 2-hydroxyethyl(meth)acrylate; β-carboxyethyl(meth)acrylate; and (meth)acrylamide. These (meth)acrylic acid-based monomers may be used alone or in combination of two or more.

Among the above(meth)acrylic acid esters, a (meth)acrylic acid ester including an alkyl group having 2 to 14 carbon atoms, preferably having 2 to 10 carbon atoms, and more preferably having 3 to 8 carbon atoms is preferable in order to enhance the fixability of the toner. In particular, n-butyl(meth)acrylate is preferable, and n-butyl acrylate is particularly preferable.

The ratio of the styrene-based monomer to the (meth)acrylic acid-based monomer in copolymerization (i.e., styrene-based monomer/(meth)acrylic acid-based monomer, on a mass basis) may be, but not limited to, 98/2 to 60/40.

The styrene-acrylic resin may have a crosslinked structure. An example of a styrene-acrylic resin having a crosslinked structure is a styrene-acrylic resin produced by the copolymerization of at least the styrene-based monomer, the (meth)acrylic acid-based monomer, and a crosslinkable monomer.

Examples of the crosslinkable monomer include difunctional or polyfunctional crosslinking agents.

Examples of the difunctional crosslinking agents include divinylbenzene, divinylnaphthalene, di(meth)acrylate compounds (e.g., diethylene glycol di(meth)acrylate, methylene-bis(meth)acrylamide, decanediol diacrylate, and glycidyl(meth)acrylate), polyester-type di(meth)acrylate, and methacrylic acid-2-([1′-methylpropylideneamino]carboxyamino)ethyl.

Examples of the crosslinking agents having three or more functional groups include tri(meth)acrylate compounds (e.g., pentaerythritol tri(meth)acrylate, trimethylolethane tri(meth)acrylate, and trimethylolpropane tri(meth)acrylate), tetra(meth)acrylate compounds (e.g., pentaerythritol tetra(meth)acrylate and oligoester(meth)acrylate), 2,2-bis(4-methacryloxy polyethoxyphenyl) propane, diallyl phthalate, triallyl cyanurate, triallyl isocyanurate, triallyl trimellitate, and diallyl chlorendate.

Among the above crosslinkable monomers, in order to enhance the fixability of the toner, a (meth)acrylate compound having two or more functional groups is preferable, a difunctional(meth)acrylate compound is more preferable, a difunctional(meth)acrylate compound including an alkylene group having 6 to 20 carbon atoms is further preferable, and a difunctional(meth)acrylate compound including a linear alkylene group having 6 to 20 carbon atoms is particularly preferable.

The ratio of the crosslinkable monomer to the all monomers in copolymerization (i.e., crosslinkable monomer/all monomers, on a mass basis) may be, but not limited to, 2/1,000 to 20/1,000.

The glass transition temperature Tg of the styrene-acrylic resin is preferably 40° C. or more and 75° C. or less and is more preferably 50° C. or more and 65° C. or less in order to enhance the fixability of the toner.

The glass transition temperature of a resin is determined from a differential scanning calorimetry (DSC) curve obtained by DSC. More specifically, the glass transition temperature of a resin is determined from the “extrapolated glass-transition-starting temperature” according to a method for determining glass transition temperature which is described in JIS K 7121:1987 “Testing Methods for Transition Temperatures of Plastics”.

The weight average molecular weight of the styrene-acrylic resin is preferably 5,000 or more and 200,000 or less, is more preferably 10,000 or more and 100,000 or less, and is particularly preferably 20,000 or more and 80,000 or less in order to enhance the preservation stability of the toner.

The weight average and number average molecular weights of a resin are determined by gel permeation chromatography (GPC). Specifically, the above molecular weights of a resin are determined by GPC using a “HLC-8120GPC” produced by Tosoh Corporation as measuring equipment, a column “TSKgel SuperHM-M (15 cm)” produced by Tosoh Corporation, and a THF solvent. The weight average and number average molecular weights of the resin are determined on the basis of the results of the measurement using a molecular-weight calibration curve based on monodisperse polystyrene standard samples.

The method for preparing the styrene-acrylic resin is not limited; various polymerization methods, such as solution polymerization, precipitation polymerization, suspension polymerization, bulk polymerization, and emulsion polymerization, may be used. The polymerization reaction may be conducted by any suitable process known in the related art, such as a batch process, a semi-continuous process, or a continuous process.

The styrene-acrylic resin and the polyester resin may coexist in the form of a mixture of the two resins or in the form of a hybrid resin that includes a styrene-acrylic resin segment and a polyester resin segment which are chemically bonded to each other (i.e., a styrene-acryl-modified polyester resin). Specifically, the hybrid resin may be formed by polymerizing a polyester monomer having an unsaturated structure, such as fumaric acid or succinic acid or a resin including the above monomer structure, which serves as a prepolymer, with a vinyl monomer, such as a styrene or an acryl.

Note that, in the case where the hybrid resin (i.e., styrene-acryl-modified polyester resin) is used, the mass ratios C and W of the polyester resin to the vinyl resin are determined and calculated as the mass ratio of the polyester segment of the hybrid resin to the vinyl resin segment (e.g., styrene-acrylic resin segment) of the hybrid resin. In the case where the hybrid resin is used in combination of a vinyl resin (e.g., styrene-acrylic resin) and a polyester resin, the mass ratios C and W of the polyester resin to the vinyl resin are determined and calculated as the ratio of the total mass of the polyester resin segment of the hybrid resin and the polyester resin to the total mass of the vinyl resin segment of the hybrid resin and the vinyl resin.

### Colorant

The colorant included in the white toner particles is a white colorant, while the colorant included in the colored toner particles is a colored colorant other than a white colorant.

Note that, if the white toner particles include a colored colorant, the colored colorant is considered a white toner when the content of a white colorant in the toner particles is 15% by mass or more.

### White Colorant

Examples of the white colorant include inorganic and organic pigments.

Specific examples of the white colorant that is an inorganic pigment include heavy calcium carbonate, precipitated calcium carbonate, titanium dioxide, aluminum hydroxide, satin white, talc, calcium sulfate, barium sulfate, zinc oxide, magnesium oxide, magnesium carbonate, amorphous silica, colloidal silica, white carbon, kaolin, calcined kaolin, delaminated kaolin, aluminosilicate, sericite, bentonite, and smectite. Specific examples of the white colorant that is an organic pigment include polystyrene resin particles and urea formalin resin particles.

Among these white colorants, at least one selected from the group consisting of titanium oxide, silicon dioxide, aluminum oxide, zinc oxide, and zirconium oxide may be used in order to form white images that has a higher hiding property and is further excellent in terms of the shades of colored images.

In particular, titanium oxide may be used as a white colorant because it is excellent in terms of a hiding property. The crystal structure of the titanium oxide may be any of anatase, rutile, and brookite.

As a white colorant, a surface-treated white colorant may be used as needed. The white colorant may be used in combination with a dispersant.

The number average particle size of the white colorant is preferably 150 nm or more and 900 nm or less, is more preferably 180 nm or more and 800 nm or less, and is further preferably 200 nm or more and 700 nm or less in order to enhance the hiding property.

The number average particle size of the white colorant is determined by adding 100 mg of the white colorant dropwise to 10 ml of a 1:1 liquid mixture of water and ethanol, dispersing the resulting mixture with an ultrasonic washer, dropping one drop of the resulting dispersion liquid to a mesh for STEM observation and immediately blowing the drop off with a blower, drying the mesh, observing the mesh with a scanning electron microscope “S-4800” produced by Hitachi High-Tech Corporation to take an STEM image, capturing the image into an image processor “LUZEX AP” produced by NIRECO CORPORATION, and analyzing the image. Specifically, the area of each of the particles is measured, and the equivalent circle diameter thereof is calculated on the basis of the area.

Specifically, the image is taken such that the number of the white colorant particles taken with the electron microscope in one field of view is about 10 or more and about 50 or less. The area of each of the articles is calculated by image analysis, and the equivalent circle diameter thereof is calculated on the basis of the area. The average of the equivalent circle diameters of 100 particles taken in a plurality of fields of view is considered the number average particle size of the white colorant.

The above white colorants may be used alone or in combination of two or more.

The content of the white colorant is preferably 15% by mass or more and 65% by mass or less, is more preferably 20% by mass or more and 60% by mass or less, and is further preferably 30% by mass or more and 50% by mass or less of the total amount of the white toner particles.

When the content of the white colorant falls within the above range, the reflectance of the white image is increased while the detachment of the image is reduced and, consequently, the color forming property of the colored image may be readily enhanced.

### Colored Colorant

Examples of the colored colorant include pigments, such as Carbon Black, Chrome Yellow, Hansa Yellow, Benzidine Yellow, Threne Yellow, Quinoline Yellow, Pigment Yellow, Permanent Orange GTR, Pyrazolone Orange, Vulcan Orange, Watching Red, Permanent Red, Brilliant Carmine 3B, Brilliant Carmine 6B, DuPont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate; and dyes, such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

The above colored colorants may be used alone or in combination of two or more.

The content of the colored colorant in the entire colored toner particles is, for example, preferably 1% by mass or more and 30% by mass or less and is more preferably 2% by mass or more and 15% by mass or less.

### Release Agent

Examples of the release agent that can be used include aliphatic hydrocarbon waxes, such as a low-molecular-weight polyethylene, a low-molecular-weight polypropylene, a polyolefin copolymer, a polyolefin wax, a microcrystalline wax, a paraffin wax, and a Fischer-Tropsch wax; waxes composed of oxides of the aliphatic hydrocarbon waxes, such as an oxidized polyethylene wax, and waxes composed of block copolymers thereof; and ester waxes composed primarily of a fatty acid ester, such as a carnauba wax, a montanic acid ester wax, and behenyl behenate. The release agent included in the colored toner particles may be an ester wax. Since an ester wax has an ester structure, it has a high chemical affinity with the polyester resin included in the binder resin and, consequently, the detachment of the colored image may be readily reduced.

### Other Additives

Examples of the other additives include additives known in the related art, such as a magnetic substance, a charge-controlling agent, and an inorganic powder. These additives may be added to the toner particles as internal additives.

Properties, etc. of Toner Particles

The toner particles may be toner particles having a single-layer structure. The toner particles may also be toner particles having a “core-shell” structure constituted by a core (i.e., core particle) and a coating layer (i.e., shell layer) covering the core.

The toner particles having a core-shell structure may be constituted by, for example, a core including a binder resin and, as needed, additives, such as a colorant and a release agent, and a coating layer including a binder resin.

There are suitable ranges of the volume average sizes of the white and colored toner particles, specifically as follows.

The volume average size Dw of the white toner particles is preferably 5.0 μm or more and 10.0 μm or less and is more preferably 6.0 μm or more and 9.0 μm or less.

The volume average size Dc of the colored toner particles is preferably 3.0 μm or more and 8.0 μm or less and is more preferably 4.0 μm or more and 7.0 μm or less.

The volume average size of the toner particles is measured using “COULTER MULTISIZER II” produced by Beckman Coulter, Inc. with an electrolyte “ISOTON-II” produced by Beckman Coulter, Inc. in the following manner.

A sample to be measured (0.5 mg or more and 50 mg or less) is added to 2 ml of a 5% aqueous solution of a surfactant (e.g., sodium alkylbenzene sulfonate) that serves as a dispersant. The resulting mixture is added to 100 ml or more and 150 ml or less of an electrolyte.

The resulting electrolyte containing the sample suspended therein is subjected to a dispersion treatment for 1 minute using an ultrasonic disperser, and the distribution of the diameters of particles having a diameter of 2 μm or more and 60 μm or less is measured using COULTER MULTISIZER II with an aperture having a diameter of 100 μm. The number of the particles sampled is 50,000.

The particle diameter distribution measured is divided into a number of particle diameter ranges (i.e., channels). For each range, in ascending order in terms of particle diameter, the cumulative volume and the cumulative number are calculated and plotted to draw cumulative distribution curves. Particle diameters at which the cumulative volume and the cumulative number reach 16% are considered to be the volume particle diameter D16v and the number particle diameter D16p, respectively. The particle diameter at which the cumulative volume reaches 50% is considered to be the volume average particle diameter D50v.

The toner particles preferably have an average circularity of 0.90 or more and 1.00 or less. The average circularity of the toner particles is more preferably 0.92 or more and 0.98 or less.

The average circularity of the toner particles is determined as [Equivalent circle perimeter]/[Perimeter](i.e., [Perimeter of a circle having the same projection area as the particles]/[Perimeter of the projection image of the particles]. Specifically, the average circularity of the toner particles is determined by the following method.

The toner particles to be measured are sampled by suction so as to form a flat stream. A static image of the particles is taken by instantaneously flashing a strobe light. The image of the particles is analyzed with a flow particle image analyzer “FPIA-3000” produced by Sysmex Corporation. The number of samples used for determining the average circularity of the toner particles is 3,500.

In the case where the toner includes an external additive, the toner (i.e., the developer) to be measured is dispersed in water containing a surfactant and then subjected to an ultrasonic wave treatment in order to remove the external additive from the toner particles.

### External Additive

Examples of the external additive include inorganic particles. Examples of the inorganic particles include SiO₂ particles, TiO₂ particles, SrTiO₃ particles, Al₂O₃ particles, CuO particles, ZnO particles, SnO₂ particles, CeO₂ particles, Fe₂O₃ particles, MgO particles, BaO particles, CaO particles, K₂O particles, Na₂O particles, ZrO₂ particles, CaO·SiO₂ particles, K₂O. (TiO₂) n particles, Al₂O₃·2SiO₂ particles, CaCO₃ particles, MgCO₃ particles, BaSO₄ particles, and MgSO₄ particles.

SiO₂ particles and Al₂O₃ particles may be used as an external additive in order to enhance the light scattering property of the white image while reducing the detachment of the colored image and thereby readily enhance the color forming property of the colored image.

The surfaces of the inorganic particles used as an external additive may be subjected to a hydrophobic treatment. The hydrophobic treatment is performed by, for example, immersing the inorganic particles in a hydrophobizing agent. Examples of the hydrophobizing agent include, but are not limited to, a silane coupling agent, a silicone oil, a titanate coupling agent, and aluminum coupling agent. These hydrophobizing agents may be used alone or in combination of two or more.

The amount of the hydrophobizing agent is commonly, for example, 1 part by mass or more and 10 parts by mass or less relative to 100 parts by mass of the inorganic particles.

Examples of the external additive further include particles of a resin, such as polystyrene, polymethyl methacrylate (PMMA), or a melamine resin; and particles of a cleaning lubricant, such as a metal salt of a higher fatty acid, such as zinc stearate, or a fluorine-contained resin.

The amount of the external additive used is, for example, preferably 0.01% by mass or more and 10% by mass or less and is more preferably 0.01% by mass or more and 6.0% by mass or less of the amount of the toner particles.

### Method for Producing Toner

A method for producing the toners (i.e., the white and colored toners) according to this exemplary embodiment is described below.

The toner according to this exemplary embodiment is produced by, after the preparation of the toner particles, depositing an external additive on the surfaces of the toner particles.

The toner particles may be prepared by any dry process, such as knead pulverization, or any wet process, such as aggregation coalescence, suspension polymerization, or dissolution suspension. A method for preparing the toner particles is not limited thereto, and any suitable method known in the related art may be used.

Among these, knead pulverization may be used for producing the white toner particles, and aggregation coalescence may be used for producing the colored toner particles.

Examples of the knead pulverization method and the aggregation coalescence method are described below. Note that the production methods are described below with no distinction of color.

### Knead Pulverization

Knead pulverization is a method for producing toner particles, the method including a kneading step of melting toner particle-forming materials (i.e., a binder resin, a colorant, etc.) and kneading the melted material to form a kneaded material; and a pulverization step of pulverizing the kneaded material.

### Kneading Step

In the kneading step, toner particle-forming materials that include a binder resin, a white colorant, etc. are kneaded. The toner particle-forming materials may include other additives, such as a release agent, as needed.

In the kneading step, 0.5 parts by mass or more and 5 parts by mass or less of an aqueous medium (e.g., water, such as distilled water or ion-exchange water, or an alcohol) may be added relative to 100 parts by mass of the toner particle-forming materials.

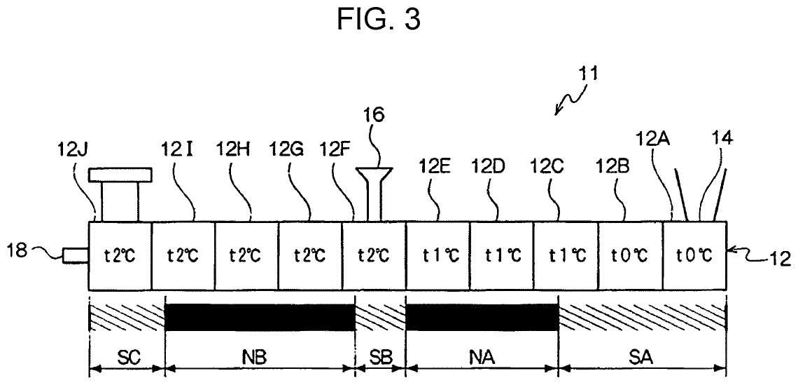

Examples of the kneader used in the kneading step include a single-screw extruder and a twin-screw extruder. Although a kneader including a feeding screw section and two kneading sections is described below with reference to FIG. 3 as an example of the kneader, the kneader is not limited thereto.

As illustrated in FIG. 3, a screw extruder 11 includes a barrel 12 equipped with a screw (not illustrated), an inlet 14 through which toner particle-forming materials, which are raw materials for the toner, are charged into the barrel 12, a liquid addition port 16 through which an aqueous medium is added to the toner particle-forming materials present in the barrel 12, and an outlet 18 through which a kneaded material formed as a result of the toner particle-forming materials being kneaded in the barrel 12 is discharged.

The barrel 12 is divided into the following sections in order of closest to the inlet 14: a feeding screw section SA in which the toner particle-forming materials charged through the inlet 14 are transported to a kneading section NA; a kneading section NA in which the toner particle-forming materials are melt-kneaded by a first kneading step; a feeding screw section SB in which the toner particle-forming materials melt-kneaded in the kneading section NA are transported to a kneading section NB; a kneading section NB in which the toner particle-forming materials are melt-kneaded by a second kneading step to form a kneaded material; and a feeding screw section SC in which the kneaded material is transported to the outlet 18.

Each of the blocks of the barrel 12 is provided with a corresponding one of temperature controllers (not illustrated) that are disposed inside the barrel 12. That is, the temperatures of the blocks 12A to 12J may be set to different temperatures.

In the state illustrated in FIG. 3, the temperatures of the blocks 12A and 12B are set to to [° C.], the temperatures of the blocks 12C to 12E are set to t1 [° C.], and the temperatures of the blocks 12F to 12J are set to t2 [° C.]. Accordingly, the toner particle-forming materials are heated to t1 [° C.] in the kneading section NA, while the toner particle-forming materials are heated to t2 [C] in the kneading section NB.

Upon the toner particle-forming materials being fed to the barrel 12 through the inlet 14, the toner particle-forming materials are transported to the kneading section NA by the feeding screw section SA. Since the temperature of the block 12C is set to t1 [° C.], the toner particle-forming materials are transported to the kneading section NA while being heated and changed into a molten state. Subsequently, since the temperatures of the blocks 12D and 12E are also set to t1 [° C.], the toner particle-forming materials are melt-kneaded at t1 [C] in the kneading section NA. In the kneading section NA, the binder resin and the release agent are brought into a molten state and subjected to a shear force by the screw.

The toner particle-forming materials kneaded in the kneading section NA are transported to the kneading section NB by the feeding screw section SB.

Subsequently, in the feeding screw section SB, an aqueous medium is charged into the barrel 12 through the liquid addition port 16 in order to add the aqueous medium to the toner particle-forming materials.

Although FIG. 3 illustrates a structure in which an aqueous medium is charged into the feeding screw section SB, the structure is not limited to this. Alternatively, the aqueous medium may be charged into the kneading section NB. In another case, the aqueous medium may be charged into both feeding screw section SB and kneading section NB. In other words, the sections into which the aqueous medium is charged and the number of the sections may be selected as needed.

As a result of the aqueous medium being charged into the barrel 12 through the liquid addition port 16, the toner particle-forming materials present in the barrel 12 are mixed with the aqueous medium. Since the toner particle-forming materials are cooled due to the latent heat of vaporization of the aqueous medium, the temperature of the toner particle-forming materials is maintained.

Finally, the toner particle-forming materials are melt-kneaded in the kneading section NB to form a kneaded material, which is transported to the outlet 18 by the feeding screw section SC and discharged through the outlet 18.

The kneading step may be conducted using the screw extruder 11 illustrated in FIG. 3 in the above-described manner.

### Cooling Step

The cooling step is a step of cooling the melt-kneaded material prepared in the melt-kneading step. In the cooling step, the temperature may be reduced from the temperature of the kneaded material at the end of the kneading step to 40° C. or less at an average cooling rate of 4° C./see or more. If the above cooling rate of the kneaded material is low, the mixture (i.e., the mixture of the binder resin, the colorant, etc.) finely dispersed in the binder resin in the kneading step may recrystallize and dispersion diameter may be increased disadvantageously. In contrast, rapidly reducing the temperature at the average cooling rate enables the dispersion state immediately after the end of the kneading step to be kept unchanged. Note that the term “average cooling rate” used herein refers to the average of the rate at which the temperature is reduced from the temperature of the kneaded material at the end of the kneading step (e.g., in the case where the screw extruder 11 illustrated in FIG. 3 is used, t2 [° C.]) to 40° C.

Specific examples of the cooling method used in the cooling step include a method in which reduction rollers, sandwich cooling belts, and the like through which cold water or brine is circulated are used. In the case where cooling is performed using the above method, the cooling rate is determined by the speed of the reduction rollers, the flow rate of the brine, the rate at which the kneaded material is fed, the thickness of the slab to which the kneaded material is rolled, and the like. The above slab thickness may be 1 mm or more and 3 mm or less.

### Pulverization Step

The kneaded material cooled in the cooling step is pulverized in the pulverization step to form particles. In the pulverization step, for example, a mechanical pulverizer or a jet pulverizer may be used. Optionally, the particles may be heated with hot air or the like in order to spheroidize the particles.

### Classification Step

The particles prepared in the pulverization step may optionally be classified in the classification step in order to produce toner particles having a volume average size that falls within the intended range. In the classification step, a centrifugal classifier, an inertial classifier, and the like, which have been used in the related art, may be used, and fine powder particles (i.e., particles having a size smaller than the intended particle size range) and coarse powder particles (i.e., particles having a size larger than the intended particle size range) are removed.

The toner particles are produced by the above-described steps.

### Aggregation Coalescence

Aggregation coalescence is, for example, a method for producing toner particles, the method including the following steps:
a step of preparing dispersion liquids (i.e., a dispersion liquid preparation step);
a step of mixing a first resin particle dispersion liquid in which particles of a first resin, which serves as a binder resin, are dispersed with a colorant dispersion liquid in which a colorant is dispersed and a release agent particle dispersion liquid in which particles of a release agent (hereinafter, referred to also as “release agent particles”) are dispersed, and causing the above particles and the colorant to aggregate with one another in the mixed dispersion liquid to form first aggregated particles (i.e., a first aggregated particle formation step);
a step of, subsequent to the preparation of a first aggregated particle dispersion liquid in which the first aggregated particles are dispersed, adding particles of a second resin that serves as a binder resin to the first aggregated particle dispersion liquid to cause the second resin particles to aggregate onto the surfaces of the first aggregated particles and form second aggregated particles (i.e., a second aggregated particle formation step); and
a step of heating a second aggregated particle dispersion liquid in which the second aggregated particles are dispersed to cause fusion and coalescence of the second aggregated particles and form toner particles (i.e., fusion-coalescence step).

Note that, although the aggregation coalescence method described below is a method for producing toner particles that include a binder resin, a colorant, and a release agent, the release agent is an optional component that may be included in the toner particles as needed.

### Dispersion Liquid Preparation Step

First, the dispersion liquids used in the aggregation coalescence method are prepared. Specifically, a first resin particle dispersion liquid in which particles of a first resin that serves as a binder resin are dispersed, a colorant dispersion liquid in which a colorant is dispersed, a second resin particle dispersion liquid in which particles of a second resin that serves as a binder resin are dispersed, and a release agent particle dispersion liquid in which release agent particles are dispersed are prepared.

In the description of the dispersion liquid preparation step, the first and second resin particles are referred to collectively as “resin particles”.

The resin particle dispersion liquid is prepared by, for example, dispersing resin particles in a dispersion medium using a surfactant.

Examples of the dispersion medium used for preparing the resin particle dispersion liquid include aqueous media.

Examples of the aqueous media include water, such as distilled water and ion-exchange water; and alcohols. These aqueous media may be used alone or in combination of two or more.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. Among these surfactants, in particular, the anionic surfactants and the cationic surfactants may be used. The nonionic surfactants may be used in combination with the anionic surfactants and the cationic surfactants.

These surfactants may be used alone or in combination of two or more.

In the preparation of the resin particle dispersion liquid, the resin particles can be dispersed in a dispersion medium by any suitable dispersion method commonly used in the related art in which, for example, a rotary-shearing homogenizer, a ball mill, a sand mill, or a dyno mill that includes media is used. Depending on the type of the resin particles used, the resin particles may be dispersed in the resin particle dispersion liquid by phase-inversion emulsification or the like.

Phase-inversion emulsification is a method in which the resin to be dispersed is dissolved in a hydrophobic organic solvent in which the resin is soluble, a base is added to the resulting organic continuous phase (i.e., O phase) to perform neutralization, and subsequently an aqueous medium (i.e., W phase) is charged in order to convert the resin from W/O to O/W (i.e., phase inversion), form an discontinuous phase, and disperse the resin in the aqueous medium in the form of particles.

The volume average size of the resin particles dispersed in the resin particle dispersion liquid is preferably, for example, 0.01 μm or more and 1 μm or less, is more preferably 0.08 μm or more and 0.8 μm or less, and is further preferably 0.1 μm or more and 0.6 μm or less.

The volume average size of the resin particles is determined in the following manner. The particle diameter distribution of the resin particles is obtained using a laser-diffraction particle-size-distribution measurement apparatus, such as “LA-700” produced by HORIBA, Ltd. The particle diameter distribution measured is divided into a number of particle diameter ranges (i.e., channels). For each range, in ascending order in terms of particle diameter, the cumulative volume is calculated and plotted to draw a cumulative distribution curve. A particle diameter at which the cumulative volume reaches 50% is considered to be the volume particle diameter D50v. The volume average sizes of particles included in the other dispersion liquids are also determined in the above-described manner.

The content of the resin particles included in the resin particle dispersion liquid is, for example, preferably 5% by mass or more and 50% by mass or less and is more preferably 10% by mass or more and 40% by mass or less.

The colorant dispersion liquid, the release agent particle dispersion liquid, and the like are also prepared as in the preparation of the resin particle dispersion liquid. In other words, the above-described specifications for the volume average diameter of the particles included in the resin particle dispersion liquid, the dispersion medium included in the resin particle dispersion liquid, the dispersion method used for preparing the resin particle dispersion liquid, and the content of the particles in the resin particle dispersion liquid can also be applied to the colorant dispersed in the colorant dispersion liquid and the release agent particles dispersed in the release agent particle dispersion liquid.

### First Aggregated Particle Formation Step

The first resin particle dispersion liquid is mixed with the colorant dispersion liquid and the release agent particle dispersion liquid.

In the resulting mixed dispersion liquid, heteroaggregation of the first resin particles with the colorant and the release agent particles is performed in order to form first aggregated particles including the resin particles, the colorant, and the release agent particles.

Specifically, for example, the pH of a dispersion liquid prepared by mixing the first resin particle dispersion liquid, the colorant dispersion liquid, and the release agent particle dispersion liquid with one another is adjusted to be acidic (e.g., pH of 2 or more and 5 or less). While a coagulant is added to the dispersion liquid or after a coagulant has been added to the dispersion liquid, the temperature of the dispersion liquid is set to 20° C. or more and 50° C. or less. Subsequently, the particles dispersed in the mixed dispersion liquid are caused to aggregate together to form first aggregated particles.

In the first aggregated particle formation step, alternatively, for example, the above coagulant may be added to the mixed dispersion liquid at room temperature (e.g., 25° C.) while the mixed dispersion liquid is stirred using a rotary-shearing homogenizer. Then, the pH of the mixed dispersion liquid is adjusted to be acidic (e.g., pH of 2 or more and 5 or less), and a dispersion stabilizer may be added to the mixed dispersion liquid as needed. Subsequently, the mixed dispersion liquid is heated in the above-described manner.

Examples of the coagulant include surfactants that have a polarity opposite to that of the surfactant added to the mixed dispersion liquid as a dispersant, inorganic metal salts, and divalent or higher metal complexes. In particular, using a metal complex as a coagulant reduces the amount of surfactant used and, as a result, charging characteristics may be enhanced.

An additive capable of forming a complex or a bond similar to a complex with the metal ions contained in the coagulant may optionally be used as needed. An example of the additive is a chelating agent.

Examples of the inorganic metal salts include metal salts, such as calcium chloride, calcium nitrate, barium chloride, magnesium chloride, zinc chloride, aluminum chloride, and aluminum sulfate; and inorganic metal salt polymers, such as polyaluminum chloride, polyaluminum hydroxide, and calcium polysulfide.

The chelating agent may be a water-soluble chelating agent. Examples of such a chelating agent include oxycarboxylic acids, such as tartaric acid, citric acid, and gluconic acid; and iminodiacetic acid (IDA), nitrilotriacetic acid (NTA), and ethylenediaminetetraacetic acid (EDTA).

The amount of the chelating agent used is, for example, preferably 0.01 parts by mass or more and 5.0 parts by mass or less and is more preferably 0.1 parts by mass or more and less than 3.0 parts by mass relative to 100 parts by mass of the first resin particles.

### Second Aggregated Particle Formation Step

After the first aggregated particle dispersion liquid, in which the first aggregated particles are dispersed, has been prepared, a mixed dispersion liquid in which the second resin particles are dispersed is added to the first aggregated particle dispersion liquid.

In the second aggregated particle formation step, a surfactant may be added to the first aggregated particle dispersion liquid.

Note that the type of resin constituting the second resin particles may be the same as or different from the type of resin constituting the first resin particles.

In a dispersion liquid that includes the first aggregated particles and the second resin particles, the second resin particles are caused to aggregate onto the surfaces of the first aggregated particles. Optionally, the release agent particle dispersion liquid may be added to the dispersion liquid in order to aggregate the second resin particles and the release agent particles onto the surfaces of the first aggregated particles. Specifically, for example, when the size of the first aggregated particles reaches an intended particle size in the first aggregated particle formation step, the second resin particle dispersion liquid is added to the first aggregated particle dispersion liquid, and the resulting mixed dispersion liquid is heated to a temperature equal to or less than the glass transition temperature of the second resin particles.

Then, the pH of the dispersion liquid is adjusted to, for example, about 6.5 or more and 8.5 or less in order to stop the aggregation.

Hereby, second aggregated particles including the first aggregated particles and the second resin particles aggregated with the first aggregated particles so as to be deposited on the surfaces thereof are formed.

### Fusion Coalescence Step

The second aggregated particle dispersion liquid in which the second aggregated particles are dispersed is heated to, for example, a temperature equal to or higher than the glass transition temperature of the first and second resin particles (e.g., [Glass transition temperature of the first and second resin particles+10° C.] or more and [the Glass transition temperature+30° C.] or less) in order to perform fusion and coalescence of the second aggregated particles and form toner particles.

The toner particles are produced through the above-described steps.

Note that, in the aggregation coalescence method described above, the second aggregated particle formation step may be omitted; toner particles may be formed by performing the fusion and coalescence of the first aggregated particles. In another case, the second aggregated particle formation step may be performed a plurality of times repeatedly.

After the completion of the fusion-coalescence step, the toner particles formed in the solution are subjected to any suitable cleaning step, solid-liquid separation step, and drying step that are known in the related art in order to obtain dried toner particles.

In the cleaning step, the toner particles may be subjected to displacement washing using ion-exchange water to a sufficient degree from the viewpoint of electrification characteristics. Examples of a solid-liquid separation method used in the solid-liquid separation step include, but are not limited to, suction filtration and pressure filtration from the viewpoint of productivity. Examples of a drying method used in the drying step include, but are not limited to, freeze-drying, flash drying, fluidized drying, and vibrating fluidized drying from the viewpoint of productivity.

In the method for producing the toner according to the exemplary embodiment of the disclosure, for example, an external additive may be mixed with toner particles prepared by the above-described method for producing the toner particles.

The mixing may be performed using a V-blender, a HENSCHEL mixer, a Lodige mixer, or the like. Optionally, coarse toner particles may be removed using a vibrating screen classifier, a wind screen classifier, or the like.

### Electrostatic-Image Developer Set

An electrostatic-image developer set according to an exemplary embodiment includes a white electrostatic-image developer including the white toner included in the toner set according to the above-described exemplary embodiment and a colored electrostatic-image developer including the colored toner included in the toner set according to the above-described exemplary embodiment.

Each of the developers included in the electrostatic-image developer set according to this exemplary embodiment may be a single-component developer that includes only the toner included in the toner set according to the above-described exemplary embodiment and may be a two-component developer that is a mixture of the above toner and a carrier.

The type of the carrier is not limited, and any suitable carrier known in the related art may be used. Examples of the carrier include a coated carrier prepared by coating the surfaces of cores including magnetic powder particles with a coat resin; a magnetic-powder-dispersed carrier prepared by dispersing and mixing magnetic powder particles in a matrix resin; and a resin-impregnated carrier prepared by impregnating a porous magnetic powder with a resin.

The magnetic-powder-dispersed carrier and the resin-impregnated carrier may also be prepared by coating the surfaces of particles constituting the carrier, that is, core particles, with a coat resin.

Examples of the magnetic powder include powders of magnetic metals, such as iron, nickel, and cobalt; and powders of magnetic oxides, such as ferrite and magnetite.

Examples of the coat resin and the matrix resin include styrene-acrylic resins; polyolefin resins, such as a polyethylene and a polypropylene; polyvinyl and polyvinylidene resins, such as polystyrene, a (meth)acrylic resin, polyacrylonitrile, polyvinyl acetate, polyvinyl alcohol, polyvinyl butyral, polyvinyl chloride, polyvinyl carbazole, polyvinyl ether, and polyvinyl ketone; vinyl chloride-vinyl acetate copolymers; straight silicone resins including an organosiloxane bond and the modified products thereof; fluorine resins, such as polytetrafluoroethylene, polyvinyl fluoride, polyvinylidene fluoride, and polychlorotrifluoroethylene; polyesters; polyurethanes; polycarbonates; amino resins, such as urea and formaldehyde resins; and epoxy resins.

It is preferable that the coat resin and the matrix resin include a (meth)acrylic resin. It is more preferable that the content of the alicyclic(meth)acrylic resin be 50% by mass or more of the total mass of the resin. It is further preferable that the content of the (meth)acrylic resin be 80% by mass or more of the total mass of the resin.

The coat resin and the matrix resin may optionally include additives, such as conductive particles.

Examples of the conductive particles include particles of metals, such as gold, silver, and copper; and particles of carbon black, titanium oxide, zinc oxide, tin oxide, barium sulfate, aluminum borate, and potassium titanate.

The surfaces of the cores can be coated with a coat resin by, for example, using a coating-layer forming solution prepared by dissolving the coat resin and, as needed, various types of additives in a suitable solvent. The type of the solvent is not limited and may be selected with consideration of the type of the coat resin used, ease of applying the coating-layer forming solution, and the like.

Specific examples of a method for coating the surfaces of the cores with the coat resin include an immersion method in which the cores are immersed in the coating-layer forming solution; a spray method in which the coating-layer forming solution is sprayed onto the surfaces of the cores; a fluidized-bed method in which the coating-layer forming solution is sprayed onto the surfaces of the cores while the cores are floated using flowing air; and a kneader-coater method in which the cores of the carrier are mixed with the coating-layer forming solution in a kneader coater and subsequently the solvent is removed.

The mixing ratio (i.e., mass ratio) of the toner to the carrier in the two-component developer is preferably toner: carrier=1:100 to 30:100 and is more preferably 3:100 to 20:100.

### Image Forming Apparatus and Image Forming Method

An image forming apparatus and an image forming method according to an exemplary embodiment of the present disclosure are described below.

An image forming apparatus according to an exemplary embodiment includes a first image formation unit including a first developing unit including the white electrostatic-image developer included in the developer set according to the above-described exemplary embodiment, the first image formation unit being capable of forming a white image; a second image formation unit including a second developing unit including the colored electrostatic-image developer included in the developer set according to the above-described exemplary embodiment, the second image formation unit being capable of forming a colored image with the colored toner; a transfer unit that transfers the white and colored images onto a surface of a recording medium; and a fixing unit that fixes the white and colored images transferred on the surface of the recording medium.

The image forming apparatus according to this exemplary embodiment may include first and second image formation units each including an image holding member; a charging unit that charges a surface of the image holding member; an electrostatic-image formation unit that forms an electrostatic image on the surface of the image holding member; and a developing unit that develops the electrostatic image formed on the surface of the image holding member with an electrostatic-image developer to form a toner image.

The image forming apparatus according to this exemplary embodiment may include an image holding member; a charging unit that charges a surface of the image holding member; an electrostatic-image formation unit that forms an electrostatic image on the surface of the image holding member; and, as first and second image formation units, first and second developing units that develop the electrostatic image formed on the surface of the image holding member with electrostatic image developers to form a toner image.

Using the image forming apparatus according to this exemplary embodiment, an image forming method including a first image formation step of forming a white image with the white toner included in the electrostatic-image developing toner set according to the above-described exemplary embodiment; a second image formation step of forming a colored image with the colored toner included in the electrostatic-image developing toner set according to the above-described exemplary embodiment; a transfer step of transferring the white and colored images to a recording medium; and a fixing step of fixing the white and colored images to the recording medium (i.e., an image forming method according to an exemplary embodiment) is implemented.

The image forming apparatus according to this exemplary embodiment may be any image forming apparatus known in the related art, such as a direct-transfer image forming apparatus in which a toner image (in this exemplary embodiment, a white image and a colored image) formed on the surface of an image holding member is directly transferred to a recording medium; an intermediate-transfer image forming apparatus in which a toner image formed on the surface of an image holding member is transferred onto the surface of an intermediate transfer body in the first transfer step and the toner image transferred on the surface of the intermediate transfer body is transferred onto the surface of a recording medium in the second transfer step; an image forming apparatus including a cleaning unit that cleans the surface of the image holding member subsequent to the transfer of the toner image before the image holding member is again charged; and an image forming apparatus including a static-eliminating unit that eliminates static by irradiating the surface of an image holding member with static-eliminating light subsequent to the transfer of the toner image before the image holding member is again charged.

In the case where the image forming apparatus according to this exemplary embodiment is the intermediate-transfer image forming apparatus, the transfer unit may be constituted by, for example, an intermediate transfer body to which a toner image is transferred, a first transfer subunit that transfers a toner image formed on the surface of the image holding member onto the surface of the intermediate transfer body in the first transfer step, and a second transfer subunit that transfers the toner image transferred on the surface of the intermediate transfer body onto the surface of a recording medium in the second transfer step.

In the image forming apparatus according to the exemplary embodiment, for example, a portion including the developing unit may have a cartridge structure (i.e., process cartridge) detachably attachable to the image forming apparatus. An example of the process cartridge is a process cartridge including a developing unit including the electrostatic image developer set according to the above-described exemplary embodiment.

The image forming apparatus according to this exemplary embodiment may be an image forming apparatus that includes a developing unit including the white toner included in the toner set according to the above-described exemplary embodiment and at least one colored toner selected from yellow, magenta, cyan, and black toners.

The recording medium on which images can be formed using the image forming apparatus (i.e., the image forming method) according to this exemplary embodiment is not limited; recording media known in the related art may be used. Examples thereof include resin films and sheets and paper sheets. The resin films and sheets may be used as, for example, packages, labels, packaging materials, advertising media, and OHP sheets.

Examples of the resin films and sheets include films and sheets composed of a polyolefin, such as polyethylene or polypropylene; films and sheets composed of a polyester, such as polyethylene terephthalate or polybutylene terephthalate; films and sheets composed of a polyamide, such as nylon; and films and sheets composed of a polycarbonate, a polystyrene, a modified polystyrene, polyvinyl chloride, polyvinyl alcohol, and polylactic acid. The above films and sheets may be any of unstretched films and sheets and uniaxially or biaxially stretched films and sheets. The resin films and sheets may have a single-layer or multilayer structure. The resin films and sheets may have a surface coat layer that facilitates the fixing of the toner and may be subjected to a corona treatment, an ozone treatment, a plasma treatment, a frame treatment, a glow discharge treatment, or the like.

Examples of the order in which the recording medium, the colored image, and the white image (i.e., an opacifying layer) are stacked on top of one another include (a), (b), and (c) below.
Order (a): Permeable recording medium/Colored image/White image (Opacifying layer), in order of closest to the viewer
Order (b): Colored image/Permeable recording medium/White image (Opacifying layer), in order of closest to the viewer
Order (c): Colored image/White image (Opacifying layer)/Recording medium (regardless of permeability), in order of closest to the viewer

An example of the image forming apparatus according to the exemplary embodiment is described below, but the image forming apparatus is not limited thereto. Hereinafter, only components illustrated in drawings are described; others are omitted.

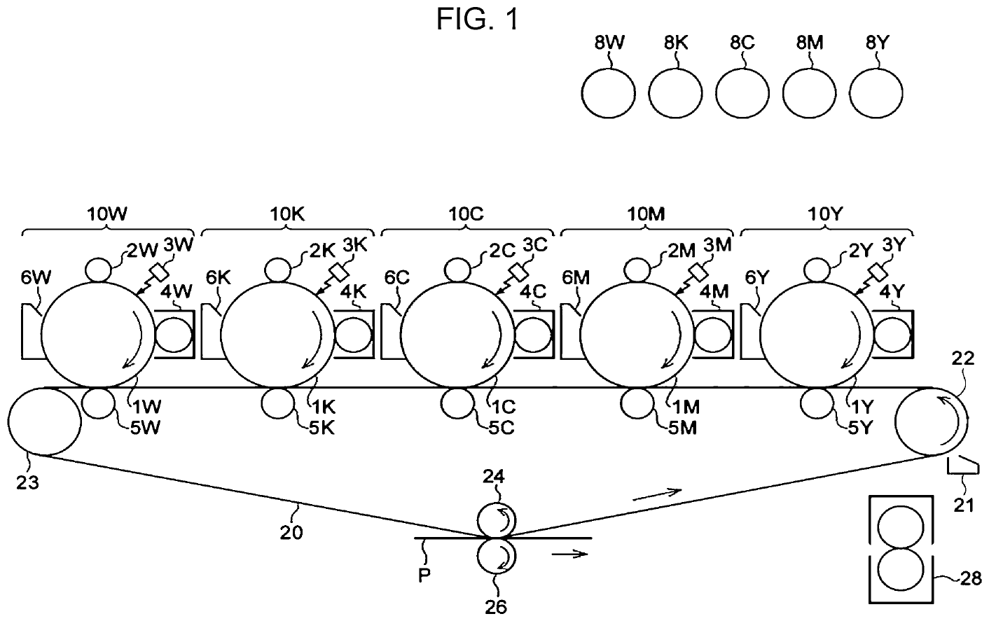

FIG. 1 schematically illustrates the image forming apparatus according to the exemplary embodiment. FIG. 1 illustrates a quintuple-tandem, intermediate transfer-type image forming apparatus.

The image forming apparatus illustrated in FIG. 1 includes first to fifth electrophotographic image formation units 10Y, 10M, 10C, 10K, and 10W that form yellow (Y), magenta (M), cyan (C), black (K), and white (W) images, respectively, on the basis of color separation image data. The image formation units (hereinafter, referred to simply as “units”) 10Y, 10M, 10C, 10K, and 10W are horizontally arranged in parallel at a predetermined distance from one another. The units 10Y, 10M, 10C, 10K, and 10W may be process cartridges detachably attachable to the image forming apparatus.

An intermediate transfer belt 20 (i.e., an example of an intermediate transfer body) runs below and extends over the units 10Y, 10M, 10C, 10K, and 10W. The intermediate transfer belt 20 is wound around a drive roller 22, a support roller, and a counter roller 24 that are arranged to contact with the inner surface of the intermediate transfer belt 20 and runs in the direction from the first unit 10Y to the fifth unit 10W. An intermediate transfer body-cleaning device 21 is disposed so as to contact with the surface of the intermediate transfer belt 20 onto which an image is to be held and to face the drive roller 22.

Developing devices (i.e., examples of the developing units) 4Y, 4M, 4C, 4K, and 4W of the units 10Y, 10M, 10C, 10K, and 10W are supplied with yellow, magenta, cyan, black, and white toners stored in toner cartridges 8Y, 8M, 8C, 8K, and 8W, respectively.

Since the first to fifth units 10Y, 10M, 10C, 10K, and 10W have the same structure and perform the same operation and the same action, the following description is made with reference to, as a representative, the first unit 10Y that forms an yellow image and is located upstream in the direction in which the intermediate transfer belt runs.

The first unit 10Y includes a photosensitive member 1Y serving as an image holding member. The following components are disposed around the photosensitive member 1Y sequentially in the counterclockwise direction: a charging roller (example of the charging unit) 2Y that charges the surface of the photosensitive member 1Y at a predetermined potential; an exposure device (example of the electrostatic-image formation unit) 3Y that forms an electrostatic image by irradiating the charged surface of the photosensitive member 1Y with a laser beam based on a color separated image signal; a developing device (example of the developing unit) 4Y that develops the electrostatic image by supplying a toner to the electrostatic image; a first transfer roller (example of the first transfer subunit) 5Y that transfers the developed toner image to the intermediate transfer belt 20; and a photosensitive-member cleaning device (example of the cleaning unit) 6Y that removes a toner remaining on the surface of the photosensitive member 1Y after the first transfer.

The first transfer roller 5Y is disposed so as to contact with the inner surface of the intermediate transfer belt 20 and to face the photosensitive member 1Y. Each of the first transfer rollers 5Y, 5M, 5C, 5K, and 5W of the respective units is connected to a bias power supply (not illustrated) that applies a first transfer bias to the first transfer rollers. Each bias power supply varies the values of transfer bias applied to the corresponding first transfer roller on the basis of the control by a controller (not illustrated).

The operation of forming a yellow image in the first unit 10Y is described below.

Before the operation starts, the surface of the photosensitive member 1Y is charged at a potential of −600 to −800 V by the charging roller 2Y.

The photosensitive member 1Y is formed by stacking a photosensitive layer on a conductive substrate (e.g., volume resistivity at 20° C.: 1×10⁻⁶ Ωcm or less). The photosensitive layer is normally of high resistance (comparable with the resistance of ordinary resins), but, upon being irradiated with the laser beam, the specific resistance of the portion irradiated with the laser beam varies. Thus, the exposure device 3Y irradiates the surface of the charged photosensitive member 1Y with the laser beam on the basis of the image data of the yellow image sent from the controller (not illustrated). As a result, an electrostatic image of yellow image pattern is formed on the surface of the photosensitive member 1Y.

The term “electrostatic image” used herein refers to an image formed on the surface of the photosensitive member 1Y by charging, the image being a “negative latent image” formed by irradiating a portion of the photosensitive layer with the laser beam emitted from the exposure device 3Y to reduce the specific resistance of the irradiated portion such that the charges on the irradiated surface of the photosensitive member 1Y discharge while the charges on the portion that is not irradiated with the laser beam remain.

The electrostatic image, which is formed on the photosensitive member 1Y as described above, is sent to the predetermined developing position by the rotating photosensitive member 1Y. The electrostatic image on the photosensitive member 1Y is developed and visualized in the form of a toner image by the developing device 4Y at the developing position.

The developing device 4Y includes an electrostatic image developer including, for example, at least, a yellow toner and a carrier. The yellow toner is stirred in the developing device 4Y to be charged by friction and supported on a developer roller (example of the developer support), carrying an electric charge of the same polarity (i.e., negative) as the electric charge generated on the photosensitive member 1Y. The yellow toner is electrostatically adhered to the eliminated latent image portion on the surface of the photosensitive member 1Y as the surface of the photosensitive member 1Y passes through the developing device 4Y. Thus, the latent image is developed using the yellow toner. The photosensitive member 1Y on which the yellow toner image is formed keeps rotating at the predetermined rate, thereby transporting the toner image developed on the photosensitive member 1Y to the predetermined first transfer position.

Upon the yellow toner image on the photosensitive member 1Y reaching the first transfer position, first transfer bias is applied to the first transfer roller 5Y so as to generate an electrostatic force on the toner image in the direction from the photosensitive member 1Y toward the first transfer roller 5Y. Thus, the toner image on the photosensitive member 1Y is transferred to the intermediate transfer belt 20. The transfer bias applied has the opposite polarity (+) to that of the toner (−) and, in the first unit 10Y, controlled to be, for example, +10 μA by a controller (not illustrated).

The toner particles remaining on the photosensitive member 1Y are removed by the photosensitive-member cleaning device 6Y and then collected.

Each of the first transfer biases applied to first transfer rollers 5M, 5C, 5K, and 5W of the second, third, fourth, and fifth units 10M, 10C, 10K, and 10W is controlled in accordance with the first unit 10Y.

Thus, the intermediate transfer belt 20, on which the yellow toner image is transferred in the first unit 10Y, is successively transported through the second to fifth units 10M, 10C, 10K, and 10W while toner images of the respective colors are stacked on top of another.

The resulting intermediate transfer belt 20 on which toner images of five colors are multiple-transferred in the first to fifth units is then transported to a second transfer section including the counter roller 24 contacting with the inner surface of the intermediate transfer belt 20 and a second transfer roller (example of the second transfer subunit) 26 disposed on the image-carrier-side of the intermediate transfer belt 20. A recording paper (example of the recording medium) P is fed by a feed mechanism into a narrow space between the second transfer roller 26 and the intermediate transfer belt 20 that contact with each other at the predetermined timing. The second transfer bias is then applied to the counter roller 24. The transfer bias applied here has the same polarity (−) as that of the toner (−) and generates an electrostatic force on the toner image in the direction from the intermediate transfer belt 20 toward the recording paper P. Thus, the toner image on the intermediate transfer belt 20 is transferred to the recording paper P. The intensity of the second transfer bias applied is determined on the basis of the resistance of the second transfer section which is detected by a resistance detector (not illustrated) that detects the resistance of the second transfer section and controlled by changing voltage.

Subsequently, the recording paper P is transported into a nip part of the fixing device (example of the fixing unit) 28 at which a pair of fixing rollers contact with each other. The toner image is fixed to the recording paper P to form a fixed image.

Examples of the recording paper P to which a toner image is transferred include plain paper used in electrophotographic copiers, printers, and the like. Instead of the recording paper P, OHP films and the like may be used as a recording medium.

The surface of the recording paper P may be smooth and flat in order to enhance the smoothness of the surface of the fixed image. Examples of such a recording paper include coated paper produced by coating the surface of plain paper with resin or the like and art paper for printing.

The recording paper P, to which the color image has been fixed, is transported toward an exit portion. Thus, the series of the steps for forming a color image are terminated.

### Process Cartridge and Toner Cartridge Set

A process cartridge according to an exemplary embodiment is described below.

The process cartridge according to this exemplary embodiment is a process cartridge detachably attachable to an image forming apparatus, the process cartridge including a first developing unit including the white electrostatic-image developer included in the electrostatic-image developer set according to the above-described exemplary embodiment; and a second developing unit including the colored electrostatic-image developer included in the electrostatic-image developer set according to the above-described exemplary embodiment.

The structure of the process cartridge according to the exemplary embodiment is not limited to the above-described one. The process cartridge according to the exemplary embodiment may further include, in addition to the developing device, at least one unit selected from an image holding member, a charging unit, an electrostatic-image formation unit, a transfer unit, etc.

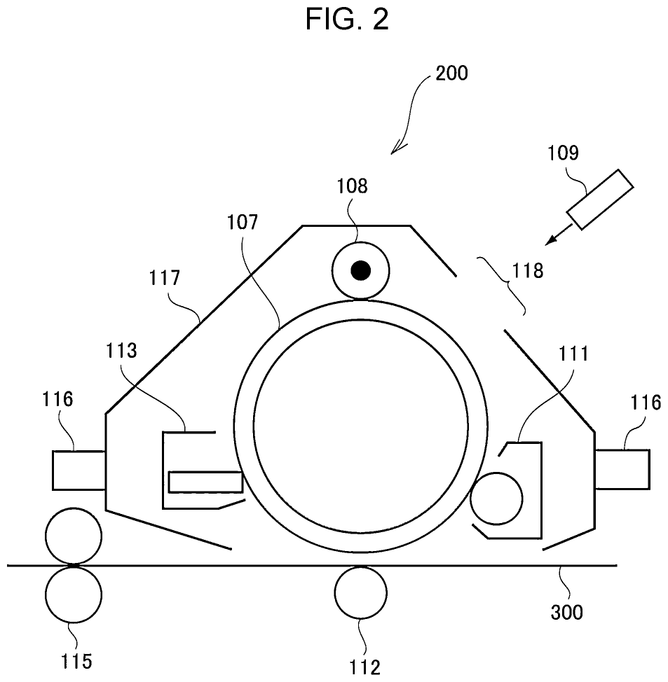

An example of the process cartridge according to the exemplary embodiment is described below, but the process cartridge is not limited thereto. Hereinafter, only components illustrated in FIG. 2 are described; others are omitted.

FIG. 2 schematically illustrates the process cartridge according to the exemplary embodiment.

A process cartridge 200 illustrated in FIG. 2 includes, for example, a photosensitive member 107 (example of the image holding member), a charging roller 108 (example of the charging unit) disposed on the periphery of the photosensitive member 107, a developing device 111 (example of the developing unit), and a photosensitive-member cleaning device 113 (example of the cleaning unit), which are combined into one unit using a housing 117 to form a cartridge. The housing 117 has an aperture 118 for exposure. A mounting rail 116 is disposed on the housing 117.

In FIG. 2, Reference numeral 109 denotes an exposure device (example of the electrostatic-image formation unit), Reference numeral 112 denotes a transfer device (example of the transfer unit), Reference numeral 115 denotes a fixing device (example of the fixing unit), and Reference numeral 300 denotes recording paper (example of the recording medium).

A toner cartridge set according to an exemplary embodiment is described below.

The toner cartridge set according to the exemplary embodiment is a toner cartridge set that includes a white toner cartridge detachably attachable to an image forming apparatus, the white toner cartridge including the white toner included in the toner set according to the above-described exemplary embodiment and a colored toner cartridge detachably attachable to an image forming apparatus, the colored toner cartridge including the colored toner included in the toner set according to the above-described exemplary embodiment. The toner cartridge set includes a replenishment toner that is to be supplied to the developing unit disposed inside an image forming apparatus.

The image forming apparatus illustrated in FIG. 2 is an image forming apparatus that includes the toner cartridges 8Y, 8M, 8C, 8K, and 8W detachably attached to the image forming apparatus. Each of the developing devices 4Y, 4M, 4C, 4K, and 4W is connected to a specific one of the toner cartridges which corresponds to the color of the developing device with a toner supply pipe (not illustrated). When the amount of toner contained in a toner cartridge is small, the toner cartridge is replaced.

### EXAMPLES

Exemplary embodiments of the present disclosure are described in detail with reference to Examples below. It should be noted that the exemplary embodiments of the present disclosure are not limited by Examples. Hereinafter, all “part” and “%” are on a mass basis unless otherwise specified.

### Preparation of Dispersion Liquids

### Synthesis of Amorphous Polyester Resin (A)

Terephthalic acid: 68 parts
Fumaric acid: 32 parts
Ethylene glycol: 42 parts
1,5-Pentanediol: 47 parts

The above materials are charged into a flask equipped with a stirring apparatus, a nitrogen introduction tube, a temperature sensor, and a fractionating column. Subsequently, the temperature is increased to 220° C. over 1 hour under a stream of nitrogen gas. Then, 1 part of titanium tetraethoxide is added to the flask relative to 100 parts of the total amount of the above materials. While the product water is removed by distillation, the temperature is then increased to 240° C. over 0.5 hours and a dehydration condensation reaction is continued for 1 hour at 240° C. Subsequently, the product of the reaction is cooled. Hereby, an amorphous polyester resin (A) having a weight average molecular weight of 97,000 and a glass transition temperature of 60° C. is prepared.

### Preparation of Amorphous Polyester Resin Particle Dispersion Liquid (A1)

Into a container equipped with a temperature control device and a nitrogen purging device, 40 parts of ethyl acetate and 25 parts of 2-butanol are charged. After the resulting mixture has been formed into a mixed solvent, 100 parts of the amorphous polyester resin (A) is gradually charged into the container to form a solution. To the solution, a 10% aqueous ammonia solution is added in an amount equivalent to an amount three times the acid value of the resin in terms of molar ratio. The resulting liquid mixture is stirred for 30 minutes. Subsequently, the inside of the container is purged with a dry nitrogen gas. While the temperature is maintained to be 40° C. and the liquid mixture is stirred, 400 parts of ion-exchange water is added dropwise to the container to perform emulsification. After the addition of the ion-exchange water has been terminated, the resulting emulsion liquid is cooled to 25° C. Hereby, a resin particle dispersion liquid containing resin particles having a volume average size of 195 nm is prepared. The solid content in the resin particle dispersion liquid is adjusted to be 20% by the addition of ion-exchange water. Hereby, an amorphous polyester resin particle dispersion liquid (A1) is prepared.

### Preparation of Styrene-Acrylic Resin Particle Dispersion Liquid (S1)

Styrene: 375 parts
n-Butyl acrylate: 25 parts
Acrylic acid: 2 parts
Dodecanethiol: 24 parts
Carbon tetrabromide: 4 parts

The above materials are mixed together to form a solution. In a flask, the mixed solution is dispersed in a surfactant solution prepared by dissolving 6 parts of a nonionic surfactant “NONIPOL 400” produced by Sanyo Chemical Industries, Ltd. and 10 parts of an anionic surfactant “TaycaPower” produced by TAYCA CORPORATION (solid content: 12%, sodium dodecylbenzenesulfonate) in 550 parts of ion-exchange water to perform emulsification. While the inside of the flask is stirred, an aqueous solution prepared by dissolving 4 parts of ammonium persulfate in 50 parts of ion-exchange water is charged into the flask over 20 minutes. After nitrogen purging has been performed, while the inside of the flask is stirred, heating is performed with an oil bath until the temperature of the contents reaches 70° C. The temperature is maintained at 70° C. for 5 hours to continue emulsion polymerization. Hereby, a resin particle dispersion liquid containing resin particles having a volume average size of 150 nm dispersed therein is prepared. The solid content in the resin particle dispersion liquid is adjusted to be 20% by the addition of ion-exchange water. Hereby, a styrene-acrylic resin particle dispersion liquid (S1) is prepared.

### Preparation of Colorant Dispersion Liquid (Cy1)

C. I. Pigment Blue 15:3 produced by Dainichiseika Color & Chemicals Mfg. Co., Ltd.: 70 parts
Anionic surfactant “Neogen RK” produced by DKS Co. Ltd.: 1 part
Ion-exchange water: 200 parts

The above materials are mixed together, and the resulting mixture is dispersed for 10 minutes with a homogenizer “ULTRA-TURRAX T50” produced by IKA. The solid content in the dispersion liquid is adjusted to 20% by the addition of ion-exchange water. Hereby, a colorant dispersion liquid (Cy1) in which colorant particles having a volume average size of 190 nm are dispersed is prepared.

### Preparation of Release Agent Particle Dispersion Liquid (W1)

Ester wax “WEP-8” produced by NOF CORPORATION (melting temperature: 79° C.): 100 parts
Anionic surfactant “TaycaPower” produced by TAYCA CORPORATION (solid content: 12%, sodium dodecylbenzenesulfonate): 1 part
Ion-exchange water: 350 parts

The above materials are mixed with one another and heated to 100° C. The resulting mixture is dispersed with a homogenizer “ULTRA-TURRAX T50” produced by IKA and then further dispersed with a pressure-discharge Gaulin homogenizer. Hereby, a release agent particle dispersion liquid in which release agent particles having a volume average size of 1,000 nm are dispersed is prepared. The solid content in the release agent particle dispersion liquid is adjusted to be 20% by the addition of ion-exchange water. Hereby, a release agent particle dispersion liquid (W1) is prepared.

### Preparation of Colored Toner

### Preparation of Cyan Toner (CT1)

First Aggregated Particle Formation Step
Ion-exchange water: 200 parts
Colorant dispersion liquid (Cy1): 15 parts
Release agent particle dispersion liquid (W1): 10 parts
Styrene-acrylic resin particle dispersion liquid (S1): 80 parts
Amorphous polyester resin particle dispersion liquid (A1): 200 parts

The above materials are charged into a round-bottom flask made of stainless steel. After the pH has been adjusted to be 3.5 by the addition of 0.1 N (0.1 mol/L) nitric acid, an aqueous magnesium chloride solution prepared by dissolving 6 parts of magnesium chloride in 30 parts of ion-exchange water is added to the flask. After dispersion has been performed with a homogenizer “ULTRA-TURRAX T50” produced by IKA at 30° C., the temperature is increased to 45° C. in a heating oil bath. Then, holding is performed until the volume average particle size reaches 4.5 μm.

### Second Aggregated Particle Formation Step

Subsequently, 45 parts of the amorphous polyester resin particle dispersion liquid (A1) and 25 parts of an anionic surfactant “TaycaPower” produced by TAYCA CORPORATION (solid content: 12%, sodium dodecylbenzenesulfonate) are added dropwise to the flask, and holding is performed for 30 minutes. Then, while stirring is continued, the pH is adjusted to 9.0 using a IN aqueous sodium hydroxide solution.

### Fusion-Coalescence Step

Subsequently, while stirring is continued, the temperature is increased to 85° C. at a heating rate of 0.05° C./min. After holding has been performed at 85° C. for 3 hours, the temperature is reduced to 30° C. at 15° C./min (i.e., first cooling). Then, the temperature is increased to 85° C. at a heating rate of 0.2° C./min (i.e., reheating). Subsequently, after holding has been performed for 30 minutes, the temperature is cooled to 30° C. at 0.5° C./min (i.e., second cooling).

Subsequently, the solid component is separated by filtration, cleaned with ion-exchange water, and then dried. Hereby, cyan toner particles (CT1) having a volume average size of 4.7 μm are prepared.

### Addition of External Additive

With 100 parts of the cyan toner particles (CT1), 1.5 parts of hydrophobic silica “RY50” produced by Nippon Aerosil Co., Ltd. is mixed. The resulting mixture is stirred with a sample mill at a rotation speed of 10,000 rpm for 30 seconds. Then, sieving is performed with a vibration sieve having an opening of 45 μm. Hereby, a cyan toner (CT1) is prepared.

### Preparation of Cyan Toner (CT2)

A cyan toner (CT2) is prepared as in the preparation of the cyan toner (CT1), except that the amounts of the styrene-acrylic resin particle dispersion liquid (S1) and the amorphous polyester resin particle dispersion liquid (A1) used in the first aggregated particle formation step are changed to 190 parts and 90 parts, respectively.

### Preparation of Cyan Toner (CT3)

A cyan toner (CT3) is prepared as in the preparation of the cyan toner (CT1), except that the amounts of the styrene-acrylic resin particle dispersion liquid (S1) and the amorphous polyester resin particle dispersion liquid (A1) used in the first aggregated particle formation step are changed to 108 parts and 172 parts, respectively.

### Preparation of Cyan Toner (CT4)

A cyan toner (CT4) is prepared as in the preparation of the cyan toner (CT1), except that the amounts of the styrene-acrylic resin particle dispersion liquid (S1) and the amorphous polyester resin particle dispersion liquid (A1) used in the first aggregated particle formation step are changed to 47 parts and 233 parts, respectively.

### Preparation of Cyan Toner (CT5)

A cyan toner (CT5) is prepared as in the preparation of the cyan toner (CT1), except that the amounts of the styrene-acrylic resin particle dispersion liquid (S1) and the amorphous polyester resin particle dispersion liquid (A1) used in the first aggregated particle formation step are changed to 30 parts and 250 parts, respectively.

### Preparation of Cyan Toner (CT6)

A cyan toner (CT6) is prepared as in the preparation of the cyan toner (CT1), except that the amount of the amorphous polyester resin particle dispersion liquid (A1) used in the second aggregated particle formation step is changed to 28 parts.

### Preparation of Cyan Toner (CT7)

A cyan toner (CT7) is prepared as in the preparation of the cyan toner (CT1), except that the amount of the amorphous polyester resin particle dispersion liquid (A1) used in the second aggregated particle formation step is changed to 38 parts.

### Preparation of Cyan Toner (CT8)

A cyan toner (CT8) is prepared as in the preparation of the cyan toner (CT1), except that the amount of the amorphous polyester resin particle dispersion liquid (A1) used in the second aggregated particle formation step is changed to 51 parts.

### Preparation of Cyan Toner (CT9)

A cyan toner (CT9) is prepared as in the preparation of the cyan toner (CT1), except that the amount of the anionic surfactant “TaycaPower” produced by TAYCA CORPORATION (solid content: 12%, sodium dodecylbenzenesulfonate) used in the second aggregated particle formation step is changed to 15 parts.

### Preparation of Cyan Toner (CT10)

A cyan toner (CT10) is prepared as in the preparation of the cyan toner (CT1), except that the amount of the anionic surfactant “TaycaPower” produced by TAYCA CORPORATION (solid content: 12%, sodium dodecylbenzenesulfonate) used in the second aggregated particle formation step is changed to 18 parts.

### Preparation of Cyan Toner (CT11)

A cyan toner (CT11) is prepared as in the preparation of the cyan toner (CT1), except that the amount of the anionic surfactant “TaycaPower” produced by TAYCA CORPORATION (solid content: 12%, sodium dodecylbenzenesulfonate) used in the second aggregated particle formation step is changed to 23 parts.

### Preparation of Cyan Toner (CT12)

A cyan toner (CT12) is prepared as in the preparation of the cyan toner (CT1), except that the amount of the anionic surfactant “TaycaPower” produced by TAYCA CORPORATION (solid content: 12%, sodium dodecylbenzenesulfonate) used in the second aggregated particle formation step is changed to 35 parts.

### Preparation of Cyan Toner (CT13)

A cyan toner (CT13) is prepared as in the preparation of the cyan toner (CT1), except that the amount of the anionic surfactant “TaycaPower” produced by TAYCA CORPORATION (solid content: 12%, sodium dodecylbenzenesulfonate) used in the second aggregated particle formation step is changed to 37 parts.

### Preparation of Cyan Toner (CT14)

A cyan toner (CT14) is prepared as in the preparation of the cyan toner (CT1), except that the amount of the anionic surfactant “TaycaPower” produced by TAYCA CORPORATION (solid content: 12%, sodium dodecylbenzenesulfonate) used in the second aggregated particle formation step is changed to 40 parts.

### Preparation of Cyan Toner (CT15)

A cyan toner (CT15) is prepared as in the preparation of the cyan toner (CT1), except that the amounts of the styrene-acrylic resin particle dispersion liquid (S1) and the amorphous polyester resin particle dispersion liquid (A1) used in the first aggregated particle formation step are changed to 206 parts and 74 parts, respectively.

### Preparation of Cyan Toner (CT16)

A cyan toner (CT16) is prepared as in the preparation of the cyan toner (CT1), except that the amounts of the styrene-acrylic resin particle dispersion liquid (S1) and the amorphous polyester resin particle dispersion liquid (A1) used in the first aggregated particle formation step are changed to 30 parts and 150 parts, respectively.

### Preparation of Cyan Toner (CT17)

A cyan toner (CT17) is prepared as in the preparation of the cyan toner (CT1), except that the amounts of the styrene-acrylic resin particle dispersion liquid (S1) and the amorphous polyester resin particle dispersion liquid (A1) used in the first aggregated particle formation step are changed to 29 parts and 251 parts, respectively, and the amount of the amorphous polyester resin particle dispersion liquid (A1) used in the second aggregated particle formation step is changed to 28 parts.

### Preparation of Cyan Toner (CT18)

A cyan toner (CT18) is prepared as in the preparation of the cyan toner (CT1), except that, in the fusion-coalescence step, while stirring is continued, the temperature is increased to 85° C. at a heating rate of 0.05° C./min, holding is then performed at 85° C. for 2 hours, and the temperature is reduced to 30° C. at 15° C./min (i.e., first cooling).

### Preparation of Cyan Toner (CT19)

A cyan toner (CT19) is prepared as in the preparation of the cyan toner (CT1), except that, in the fusion-coalescence step, while stirring is continued, the temperature is increased to 85° C. at a heating rate of 0.05° C./min, holding is then performed at 85° C. for 1 hour, and the temperature is reduced to 30° C. at 15° C./min (i.e., first cooling).

### Preparation of Cyan Toner (CT20)

A cyan toner (CT20) is prepared as in the preparation of the cyan toner (CT1), except that the amounts of the styrene-acrylic resin particle dispersion liquid (S1) and the amorphous polyester resin particle dispersion liquid (A1) used in the first aggregated particle formation step are changed to 216 parts and 64 parts, respectively.

### Preparation of Cyan Toner (CT21)

A cyan toner (CT21) is prepared as in the preparation of the cyan toner (CT1), except that the amounts of the styrene-acrylic resin particle dispersion liquid (S1) and the amorphous polyester resin particle dispersion liquid (A1) used in the first aggregated particle formation step are changed to 20 parts and 260 parts, respectively.

### Preparation of Cyan Toner (CT22)

A cyan toner (CT22) is prepared as in the preparation of the cyan toner (CT1), except that the amount of the amorphous polyester resin particle dispersion liquid (A1) used in the second aggregated particle formation step is changed to 25 parts.

### Preparation of White Toner

### Preparation of White Toner (WT1)

Preparation of Toner Particle-Forming Materials

The following materials are prepared as toner particle-forming materials.
Polyester resin (polyester resin synthesized using bisphenol A propylene oxide 2-mol adduct/ethylene oxide 2-mol adduct, terephthalic acid, and trimellitic acid as principal components with a tin catalyst): 95 parts
Styrene-acrylic resin (resin produced by polymerizing styrene and butyl acrylate under reflux of cumene): 20 parts
White colorant (titanium oxide particles, “CR-60” produced by Ishihara Sangyo Kaisha, Ltd.): 80 parts
Release agent (polypropylene, “HI-WAX NP055” produced by Mitsui Chemicals, Inc.): 5 parts

### Kneading Step

The above toner-forming materials are mixed together using a Henschel mixer. The resulting mixture is kneaded using the twin-screw extruder (i.e., a continuous kneader) illustrated in FIG. 3 under the conditions below. The rotation speed of the screw is set to 500 rpm.
Preset temperature for the feeding section (i.e., blocks 12A and 12B): 20° C.
Preset kneading temperature for the kneading section 1 (i.e., blocks 12C to 12E): 100° C.
Preset kneading temperature for the kneading section 2 (i.e., blocks 12F to 12J): 110° C.
Amount of aqueous medium (i.e., distilled water) added, relative to 100 parts of raw materials fed: 1.5 parts

When kneading is performed under the above conditions, the temperature of the resulting kneaded material at the outlet of the screw extruder 11 (i.e., the outlet 18) is 120° C. The kneaded material is rapidly cooled with rolling rollers through which a brine having a temperature of −5° C. is passed and slab-sandwich cooling belts in which cooling is performed using cold water of 2° C. The cooled material is crushed with a hammer mill. The rapid-cooling rate is confirmed by changing the speed of the cooling belts, and the average cooling rate is 10° C./sec.

The kneaded material prepared in the second kneading step is pulverized using the pulverizer “AFG400” included in the coarse particle classifier to form pulverized particles. Subsequently, classification is performed using an inertial classifier in order to remove fine and coarse powder particles. Hereby, white toner particles (WT1) having a volume average size of 6.0 μm are prepared.

### Addition of External Additive

To the white toner particles (W1), 1.2 parts of spherical silica particles treated with hexamethyldisilazane which have an average size of 130 nm are added. The resulting mixture is stirred (i.e., the external additive is added to the toner particles) for 10 minutes with a Henschel mixer. Then, sieving is performed at 45 μm with a wind screen classifier “Hi-BOLTER”. Hereby, a white toner (WT1) is prepared.

### Preparation of White Toner (WT2)

A white toner (WT2) is prepared as in the preparation of the white toner (WT1), except that, in the preparation of the toner particle-forming materials, the amounts of the polyester resin and styrene-acrylic resin are changed to 81 parts and 34 parts, respectively.

### Preparation of White Toner (WT3)

A white toner (WT3) is prepared as in the preparation of the white toner (WT1), except that, in the preparation of the toner particle-forming materials, the amounts of the polyester resin and styrene-acrylic resin are changed to 90 parts and 25 parts, respectively.

### Preparation of White Toner (WT4)

A white toner (WT4) is prepared as in the preparation of the white toner (WT1), except that, in the preparation of the toner particle-forming materials, the amounts of the polyester resin and styrene-acrylic resin are changed to 102 parts and 13 parts, respectively.

### Preparation of White Toner (WT5)

A white toner (WT5) is prepared as in the preparation of the white toner (WT1), except that, in the preparation of the toner particle-forming materials, the amounts of the polyester resin and styrene-acrylic resin are changed to 106 parts and 9 parts, respectively.

### Preparation of White Toner (WT6)

A white toner (WT6) is prepared as in the preparation of the white toner (WT1), except that, in the preparation of the toner particle-forming materials, the amounts of the polyester resin and styrene-acrylic resin are changed to 59 parts and 56 parts, respectively.

### Preparation of White Toner (WT7)

A white toner (WT7) is prepared as in the preparation of the white toner (WT1), except that, in the preparation of the toner particle-forming materials, the amounts of the polyester resin and styrene-acrylic resin are changed to 82 parts and 33 parts, respectively.

### Preparation of White Toner (WT8)

A white toner (WT8) is prepared as in the preparation of the white toner (WT1), except that, in the preparation of the toner particle-forming materials, the amounts of the polyester resin and styrene-acrylic resin are changed to 87 parts and 28 parts, respectively.

### Preparation of White Toner (WT9)

A white toner (WT9) is prepared as in the preparation of the white toner (WT1), except that, in the preparation of the toner particle-forming materials, the amounts of the polyester resin and styrene-acrylic resin are changed to 100 parts and 15 parts, respectively.

### Preparation of White Toner (WT10)

A white toner (WT10) is prepared as in the preparation of the white toner (WT1), except that, in the preparation of the toner particle-forming materials, the amounts of the polyester resin and styrene-acrylic resin are changed to 103 parts and 12 parts, respectively.

### Preparation of White Toner (WT11)

A white toner (WT11) is prepared as in the preparation of the white toner (WT1), except that, in the preparation of the toner particle-forming materials, the amounts of the polyester resin and styrene-acrylic resin are changed to 105 parts and 10 parts, respectively.

### Preparation of White Toner (WT12)

A white toner (WT12) is prepared as in the preparation of the white toner (WT1), except that, in the preparation of the toner particle-forming materials, the amounts of the polyester resin and styrene-acrylic resin are changed to 80 parts and 35 parts, respectively.

### Preparation of White Toner (WT13)

A white toner (WT13) is prepared as in the preparation of the white toner (WT1), except that, in the preparation of the toner particle-forming materials, the amounts of the polyester resin and styrene-acrylic resin are changed to 110 parts and 5 parts, respectively.

### Preparation of White Toner (WT14)

A white toner (WT14) is prepared as in the preparation of the white toner (WT1), except that, in the preparation of the toner particle-forming materials, the amounts of the polyester resin and styrene-acrylic resin are changed to 115 parts and 0 part, respectively.

### Preparation of White Toner (WT15)

A white toner (WT15) is prepared as in the preparation of the white toner (WT1), except that, in the preparation of the toner particle-forming materials, the amounts of the polyester resin and styrene-acrylic resin are changed to 79 parts and 36 parts, respectively.

### Preparation of White Toner (WT16)

A white toner (WT16) is prepared as in the preparation of the white toner (WT1), except that, in the preparation of the toner particle-forming materials, the amounts of the polyester resin and styrene-acrylic resin are changed to 109 parts and 6 parts, respectively.

### Examples 1 to 27 and Comparative Examples 1 to 3

The toner sets of the cyan and white toners listed in Table 1 are used as toner sets of Examples 1 to 27 and Comparative Examples 1 to 3.

The cyan toner of each of the toner sets of Examples 1 to 27 and Comparative Examples 1 to 3 and a carrier (CA) prepared by the following method are charged into a V-blender at a mass ratio (toner/carrier) of 5/95. The resulting mixture is stirred for 20 minutes to form cyan developers of Examples 1 to 27 and Comparative Examples 1 to 3.

The white toner of each of the toner sets of Examples 1 to 27 and Comparative Examples 1 to 3 and a carrier (CB) prepared by the following method are charged into a V-blender at a mass ratio (toner/carrier) of 8/92. The resulting mixture is stirred for 20 minutes to form white developers of Examples 1 to 27 and Comparative Examples 1 to 3.

The cyan and white developers of Examples 1 to 27 and Comparative Examples 1 to 3 are used as developer sets of Examples 1 to 27 and Comparative Examples 1 to 3.

### Preparation of Carrier (CA)

After 500 parts of spherical magnetite powder particles (volume average size: 0.55 μm) have been stirred with a Henschel mixer, 5 parts of a titanate coupling agent is added to the magnetite powder particles. The resulting mixture is heated to 100° C. and then stirred for 30 minutes. Subsequently, 6.25 parts of phenol, 9.25 parts of 35% formalin, 500 parts of the magnetite particles treated with a titanate coupling agent, 6.25 parts of 25% ammonia water, and 425 parts of water are charged into a four-necked flask. While stirring is performed, a reaction is conducted at 85° C. for 120 minutes. Subsequently, the temperature is reduced to 25° C. After 500 parts of water has been added to the flask, the supernatant is removed and the precipitate is washed with water. The washed precipitate is dried by heating under reduced pressure. Hereby, a carrier (CA) having an average particle size of 35 μm is prepared.

### Preparation of Carrier (CB)

A liquid mixture prepared by dissolving 2.0 parts of a cyclohexyl methacrylate resin (weight average molecular weight: 150,000), 0.6 parts of carbon black “VXC72”, and 0.3 parts by mass of melamine beads “Epostar S” in 10 parts of toluene is applied to 100 parts of ferrite core particles having a volume average size of 35 μm using a kneader. Hereby, a carrier (CB) is prepared.

### Evaluations

The developer sets prepared in Examples and Comparative Examples are subjected to evaluations below.

The developers included in one of the developer sets prepared in Examples and Comparative Examples are charged into an image forming apparatus, which is a modified production printer “Iridesse Production Press” produced by FUJIFILM Business Innovation Corp.

The following evaluations are made using the image forming apparatus.

### Evaluation of Color Forming Property of Colored Image

The color forming property of the colored image is evaluated on the basis of the hue angles of a solid white image and a solid cyan image formed on the solid white image.

The output chart used for the evaluation of hue angles is the image sample of “The society of Electrophotography of Japan, Test Chart No. 5-1”.

The hue angles of the solid white image and the colored image formed on the solid white image are determined by forming a solid white image on 100 sheets at a white toner deposition density of 8.0 g/m², forming colored images on the respective white images at a colored toner deposition density of 6.0 g/m², taking one in every ten sheets (i.e., 10 sheets in total) from the printed sheets, and calculating the hue angle θ of each of the colored images at 10 positions on the edge (10 mm from the edge) of the image and 10 positions inside the image with “X-Rite 939” produced by X-Rite, Inc. (aperture diameter: 4 mm) on the basis of the coordinate values (i.e., L*, a*, and b* values) of the CIE 1976 L*a*b* color system.

On the basis of the color difference Δθ between the maximum and minimum values of the hue angle θ of the color image, the color forming property of the colored image formed on the solid white image is evaluated in accordance with the evaluation standard below.

Note that the smaller the color difference Δθ between the maximum and minimum values of the hue angle θ of the color image, the higher the color reproducibility.

### Standard (Δθ) for Evaluating Color Forming Property of Colored Image

A: The color forming property of the colored image, which is an upper image, is not impaired and exhibited in a suitable manner (Δθ≤2).

A−: The color forming property of the colored image, which is an upper image, is not impaired and exhibited in a suitable manner (2<Δθ≤3).

B+: The color forming property of the colored image, which is an upper image, is not impaired and exhibited (3<Δθ≤4).

B: The color forming property of the colored image, which is an upper image, is not impaired and exhibited (4<Δθ≤5).

C: The color forming property of the colored image, which is an upper image, is impaired and degraded (5<Δθ).

### Evaluation of Image Rubbing

White and cyan images having a 1 inch×1 inch size (2.54 cm×2.54 cm) is formed on an A4-size black paper sheet (76.7 g/m²) produced by Marubeni Forest LinX Co., Ltd. in order of closest to the paper sheet under normal-temperature, normal-humidity (25° C., 50% RH) conditions such that the toner deposition densities of the white and cyan toners on the paper sheet are 8 g/m² and 4 g/m², respectively.

The image is rubbed with cotton 10 times in a reciprocating manner.

After the image has been rubbed, the loss of the image is evaluated. The evaluation is made in accordance with the following standard.

### Evaluation Standard

A: Roughening of the image is negligible.

A−: Roughening of the image is acceptable.

B+: Slight roughening of the image can be confirmed but is acceptable for practical use.

B: Roughening of the image can be confirmed but is acceptable for practical use.

C: Roughening of the image occurs at an unacceptable level for practical use.

Table 1 lists the following properties of the white and colored toners (i.e., cyan toners, in Examples above).
The content of the vinyl resin in the colored toner particles, % by mass (in Table 1, referred to as “Proportion of StAc, CS”)
The content of the polyester resin in the colored toner particles, % by mass (in Table 1, referred to as “Proportion of PES, CP”)
The mass ratio C of the polyester resin to the vinyl resin in the colored toner particles (referred to as “PES/StAc, C”)
The content of the vinyl resin in the white toner particles, % by mass (in Table 1, referred to as “Proportion of StAc, WS”)
The content of the polyester resin in the white toner particles, % by mass (in Table 1, referred to as “Proportion of PES, WP”)
The mass ratio W of the polyester resin to the vinyl resin in the white toner particles (referred to as “PES/StAc, W”)
The area fraction of the polyester resin present in a surface layer region of the colored toner particles, the surface layer region corresponding to 15% of the area of the cross section of the colored toner particles, when a cross section of the colored toner particles is observed (in Table 1, referred to as “Area fraction of surface-layer PES”)
The area fraction of the polyester resin present in an inside region of the colored toner particles, the inside region being closer to the center than the surface layer region of the colored toner particles, when a cross section of the colored toner particles is observed (in Table 1, referred to as “Area fraction of internal PES”)
The ratio X (perimeter/equivalent-circle perimeter) of the perimeter of the colored toner particles to the equivalent-circle perimeter of the colored toner particles, when a cross section of the colored toner particles is observed (in Table 1, referred to as “Ratio X”).
The Net intensity of the sulfur element included in the colored toner particles which is determined by X-ray fluorescence spectrometry (in Table 1, referred to as “Net intensity of S element”)
The content of the white colorant in the white toner particles, % by mass (in Table 1, referred to as “Colorant content”)

TABLE 1

| | Colored toner (Cyan toner) | | | | | | | |
|---|---|---|---|---|---|---|---|---|
| | | | | Area | Area | | Net | |
| | | | | fraction of | fraction | | intensity | |
| | Proportion | Proportion | PES/ | surface- | of | | of S | |
| | of StAc | of PES | StAc | layer PES | internal | Ratio | element | |
| | CS (mass %) | CP (mass %) | C | (%) | PES (%) | X | (kcps) | Type |
| Example 1 | 23 | 70 | 3.1 | 91 | 35 | 1.08 | 4.1 | CT1 |
| Example 2 | 54 | 39 | 0.7 | 88 | 15 | 1.08 | 4.4 | CT2 |
| Example 3 | 31 | 62 | 2.0 | 90 | 30 | 1.08 | 4.2 | CT3 |
| Example 4 | 13 | 80 | 6.0 | 92 | 42 | 1.08 | 4.0 | CT4 |
| Example 5 | 9 | 84 | 9.8 | 92 | 45 | 1.08 | 4.0 | CT5 |
| Example 6 | 23 | 65 | 2.9 | 62 | 37 | 1.08 | 4.1 | CT6 |
| Example 7 | 23 | 68 | 3.0 | 79 | 36 | 1.08 | 4.1 | CT7 |
| Example 8 | 23 | 72 | 3.1 | 100 | 35 | 1.08 | 4.1 | CT8 |
| Example 9 | 23 | 70 | 3.1 | 91 | 35 | 1.08 | 4.1 | CT1 |
| Example 10 | 23 | 70 | 3.1 | 91 | 35 | 1.08 | 4.1 | CT1 |
| Example 11 | 23 | 70 | 3.1 | 91 | 35 | 1.08 | 4.1 | CT1 |
| Example 12 | 23 | 70 | 3.1 | 91 | 35 | 1.08 | 4.1 | CT1 |
| Example 13 | 23 | 70 | 3.1 | 91 | 35 | 1.08 | 4.1 | CT1 |
| Example 14 | 23 | 70 | 3.1 | 91 | 35 | 1.08 | 4.1 | CT1 |
| Example 15 | 23 | 70 | 3.1 | 91 | 35 | 1.08 | 2.5 | CT9 |
| Example 16 | 23 | 70 | 3.1 | 91 | 35 | 1.08 | 3.0 | CT10 |
| Example 17 | 23 | 70 | 3.1 | 91 | 35 | 1.08 | 3.8 | CT11 |
| Example 18 | 23 | 70 | 3.1 | 91 | 35 | 1.08 | 5.7 | CT12 |
| Example 19 | 23 | 70 | 3.1 | 91 | 35 | 1.08 | 6.0 | CT13 |
| Example 20 | 23 | 70 | 3.1 | 91 | 35 | 1.08 | 6.5 | CT14 |
| Example 21 | 59 | 34 | 0.6 | 88 | 13 | 1.08 | 4.4 | CT15 |
| Example 22 | 54 | 39 | 0.7 | 88 | 15 | 1.08 | 4.4 | CT2 |
| Example 23 | 9 | 84 | 9.8 | 92 | 45 | 1.08 | 4.0 | CT16 |
| Example 24 | 8 | 80 | 9.6 | 63 | 48 | 1.08 | 3.9 | CT17 |
| Example 25 | 23 | 70 | 3.1 | 91 | 35 | 1.14 | 4.1 | CT18 |
| Example 26 | 23 | 70 | 3.1 | 91 | 35 | 1.20 | 4.1 | CT19 |
| Example 27 | 23 | 70 | 3.1 | 91 | 35 | 1.08 | 4.1 | CT1 |
| Comparative | 62 | 31 | 0.5 | 87 | 11 | 1.08 | 4.5 | CT20 |
| Example 1 | | | | | | | | |
| Comparative | 6 | 87 | 15.3 | 92 | 47 | 1.08 | 3.9 | CT21 |
| Example 2 | | | | | | | | |
| Comparative | 23 | 64 | 2.8 | 56 | 38 | 1.08 | 4.1 | CT22 |
| Example 3 | | | | | | | | |

| | White toner | | | | | | | | | |
|---|---|---|---|---|---|---|---|---|---|---|
| | Proportion | Proportion | | | | | | | Evaluations | |
| | of StAc | of PES | PES/ | Colorant | | | | | Color | |
| | WS | WF | StAc | content | | PES | StAc | | forming | Image |
| | (mass %) | (mass %) | W | (mass %) | Type | (part) | (part) | W − C | property | rubbing |
| Example 1 | 10 | 48 | 4.8 | 40 | WT1 | 95 | 20 | 1.7 | A | A |
| Example 2 | 17 | 41 | 2.4 | 40 | WT2 | 81 | 34 | 1.7 | A | B |
| Example 3 | 13 | 45 | 3.6 | 40 | WT3 | 90 | 25 | 1.6 | A | A |
| Example 4 | 7 | 51 | 7.8 | 40 | WT4 | 102 | 13 | 1.9 | A | A |
| Example 5 | 5 | 53 | 11.8 | 40 | WT5 | 106 | 9 | 1.9 | B | A |
| Example 6 | 10 | 48 | 4.8 | 40 | WT1 | 95 | 20 | 1.9 | B | A |
| Example 7 | 10 | 48 | 4.8 | 40 | WT1 | 95 | 20 | 1.8 | A | A |
| Example 8 | 10 | 48 | 4.8 | 40 | WT1 | 95 | 20 | 1.6 | A | A |
| Example 9 | 28 | 30 | 1.1 | 40 | WT6 | 59 | 56 | −2.0 | B+ | A− |
| Example 10 | 17 | 41 | 2.5 | 40 | WT7 | 82 | 33 | −0.6 | A− | A |
| Example 11 | 14 | 44 | 3.1 | 40 | WT8 | 87 | 28 | 0.0 | A | A |
| Example 12 | 8 | 50 | 6.7 | 40 | WT9 | 100 | 15 | 3.6 | A | A |
| Example 13 | 6 | 52 | 8.6 | 40 | WT10 | 103 | 12 | 5.5 | A | A− |
| Example 14 | 5 | 53 | 10.5 | 40 | WT11 | 105 | 10 | 7.4 | A− | B+ |
| Example 15 | 10 | 48 | 4.8 | 40 | WT1 | 95 | 20 | 1.7 | B+ | B+ |
| Example 16 | 10 | 48 | 4.8 | 40 | WT1 | 95 | 20 | 1.7 | A− | A− |
| Example 17 | 10 | 48 | 4.8 | 40 | WT1 | 95 | 20 | 1.7 | A | A |
| Example 18 | 10 | 48 | 4.8 | 40 | WT1 | 95 | 20 | 1.7 | A | A |
| Example 19 | 10 | 48 | 4.8 | 40 | WT1 | 95 | 20 | 1.7 | A− | A− |
| Example 20 | 10 | 48 | 4.8 | 40 | WT1 | 95 | 20 | 1.7 | B+ | B+ |
| Example 21 | 18 | 40 | 2.3 | 40 | WT12 | 80 | 35 | 1.7 | B+ | B+ |
| Example 22 | 17 | 41 | 2.4 | 40 | WT2 | 81 | 34 | 1.7 | A− | A− |
| Example 23 | 5 | 53 | 11.8 | 40 | WT5 | 106 | 9 | 1.9 | A− | A− |
| Example 24 | 3 | 55 | 22.0 | 40 | WT13 | 110 | 5 | 2.7 | B | B+ |
| Example 25 | 10 | 48 | 4.8 | 40 | WT1 | 95 | 20 | 1.7 | A | A |
| Example 26 | 10 | 48 | 4.8 | 40 | WT1 | 95 | 20 | 1.7 | A | A− |
| Example 27 | 0 | 58 | — | 40 | WT14 | 115 | 0 | — | A | B |
| Comparative | 18 | 40 | 2.2 | 40 | WT15 | 79 | 36 | 1.7 | A | C |
| Example 1 | | | | | | | | | | |
| Comparative | 3 | 55 | 18.2 | 40 | WT16 | 109 | 6 | 2.9 | C | B+ |
| Example 2 | | | | | | | | | | |
| Comparative | 10 | 48 | 4.8 | 40 | WT1 | 95 | 20 | 1.9 | C | A |
| Example 3 | | | | | | | | | | |

The above results confirm that, in Examples, since the color forming property of the colored image is high and roughening of images is unlikely to occur in the image rubbing evaluation, the color forming property of an image that includes a white image and a colored image formed thereon may be high and the detachment of the colored image may be reduced compared with Comparative Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) An electrostatic-image developing toner set including:
a white toner including white toner particles including a polyester resin and a white colorant; and
a colored toner other than a white toner, the colored toner including colored toner particles including a vinyl resin, a polyester resin, and a colored colorant,
wherein a mass ratio C of the polyester resin included in the colored toner particles to the vinyl resin included in the colored toner particles is 0.7 or more and 10 or less, and
when a cross section of the colored toner particles is observed, an area fraction of the polyester resin present in a surface layer region of the colored toner particles, the surface layer region corresponding to 15% of an area of the cross section of the colored toner particles, is 60% or more and 100% or less.

(((2))) The electrostatic-image developing toner set according to (((1))),
wherein the mass ratio C of the polyester resin included in the colored toner particles to the vinyl resin included in the colored toner particles is 2 or more and 6 or less.

(((3))) The electrostatic-image developing toner set according to (((1))) or (((2))),
wherein, when the cross section of the colored toner particles is observed, the area fraction of the polyester resin present in the surface layer region of the colored toner particles, the surface layer region corresponding to 15% of an area of the cross section of the colored toner particles, is 78% or more and 100% or less.

(((4))) The electrostatic-image developing toner set according to any one of (((1))) to (((3))),
wherein the white toner particles include a vinyl resin.

(((5))) The electrostatic-image developing toner set according to (((4))),
wherein a relationship between a mass ratio W of the polyester resin included in the white toner particles to the vinyl resin included in the white toner particles and the mass ratio C of the polyester resin included in the colored toner particles to the vinyl resin included in the colored toner satisfies-0.6≤W-C≤5.6.

(((6))) The electrostatic-image developing toner set according to (((5))),
wherein the relationship between the mass ratio W of the polyester resin included in the white toner particles to the vinyl resin included in the white toner particles and the mass ratio C of the polyester resin included in the colored toner particles to the vinyl resin included in the colored toner satisfies 0≤W-C≤4.

(((7))) The electrostatic-image developing toner set according to any one of (((1))) to (((6))),
wherein a Net intensity of a sulfur element included in the colored toner particles, the Net intensity being determined by X-ray fluorescence spectrometry, is 3.0 kcps or more and 6.0 kcps or less.

(((8))) The electrostatic-image developing toner set according to (((7))),
wherein the Net intensity of the sulfur element included in the colored toner particles, the Net intensity being determined by X-ray fluorescence spectrometry, is 3.8 kcps or more and 5.7 kcps or less.

(((9))) The electrostatic-image developing toner set according to any one of (((1))) to (((8))),
wherein, when the cross section of the colored toner particles is observed, an area fraction of the polyester resin present in an inside region of the colored toner particles, the inside region being closer to the center than the surface layer region of the colored toner particles, is 15% or more and 45% or less.

(((10))) The electrostatic-image developing toner set according to any one of (((1))) to (((9))),
wherein, when the cross section of the colored toner particles is observed, a ratio X (perimeter/equivalent-circle perimeter) of a perimeter of the colored toner particles to an equivalent-circle perimeter of the colored toner particles is 1.14 or less.

(((11))) An electrostatic-image developer set including:
a white electrostatic-image developer including the white toner included in the electrostatic-image developing toner set according to any one of (((1))) to (((10))); and
a colored electrostatic-image developer including the colored toner included in the electrostatic-image developing toner set according to any one of (((1))) to (((10))).

(((12))) A toner cartridge set including:
a white toner cartridge detachably attachable to an image forming apparatus, the white toner cartridge including the white toner included in the electrostatic-image developing toner set according to any one of (((1))) to (((10))); and
a colored toner cartridge detachably attachable to an image forming apparatus, the colored toner cartridge including the colored toner included in the electrostatic-image developing toner set according to any one of (((1))) to (((10))).

(((13))) A process cartridge detachably attachable to an image forming apparatus, the process cartridge including:
a first developing unit including the white electrostatic-image developer included in the electrostatic-image developer set according to (((11))); and
a second developing unit including the colored electrostatic-image developer included in the electrostatic-image developer set according to (((11))).

(((14))) An image forming apparatus including:
a first image formation unit including a first developing unit including the white electrostatic-image developer included in the electrostatic-image developer set according to (((11))), the first image formation unit being capable of forming a white image with the white toner;
a second image formation unit including a second developing unit including the colored electrostatic-image developer included in the electrostatic-image developer set according to (((11))), the second image formation unit being capable of forming a colored image with the colored toner;
a transfer unit that transfers the white and colored images onto a surface of a recording medium; and
a fixing unit that fixes the white and colored images transferred on the surface of the recording medium.

(((15))) An image forming method including:
forming a white image with the white toner included in the electrostatic-image developing toner set according to any one of (((1))) to (((10)));
forming a colored image with the colored toner included in the electrostatic-image developing toner set according to any one of (((1))) to (((10)));
transferring the white and colored images onto a surface of a recording medium; and
fixing the white and colored images transferred on the surface of the recording medium.

What is claimed is:

1. An electrostatic-image developing toner set comprising:
a white toner including white toner particles including a polyester resin and a white colorant; and
a colored toner other than a white toner, the colored toner including colored toner particles including a vinyl resin, a polyester resin, and a colored colorant,
wherein a mass ratio C of the polyester resin included in the colored toner particles to the vinyl resin included in the colored toner particles is 0.7 or more and 10 or less, and
when a cross section of the colored toner particles is observed, an area fraction of the polyester resin present in a surface layer region of the colored toner particles, the surface layer region corresponding to 15% of an area of the cross section of the colored toner particles, is 60% or more and 100% or less.

2. The electrostatic-image developing toner set according to claim 1,
wherein the mass ratio C of the polyester resin included in the colored toner particles to the vinyl resin included in the colored toner particles is 2 or more and 6 or less.

3. The electrostatic-image developing toner set according to claim 1,
wherein, when the cross section of the colored toner particles is observed, the area fraction of the polyester resin present in the surface layer region of the colored toner particles, the surface layer region corresponding to 15% of an area of the cross section of the colored toner particles, is 78% or more and 100% or less.

4. The electrostatic-image developing toner set according to claim 1,
wherein the white toner particles include a vinyl resin.

5. The electrostatic-image developing toner set according to claim 4,
wherein a relationship between a mass ratio W of the polyester resin included in the white toner particles to the vinyl resin included in the white toner particles and the mass ratio C of the polyester resin included in the colored toner particles to the vinyl resin included in the colored toner satisfies-0.6≤W-C≤5.6.

6. The electrostatic-image developing toner set according to claim 5,
wherein the relationship between the mass ratio W of the polyester resin included in the white toner particles to the vinyl resin included in the white toner particles and the mass ratio C of the polyester resin included in the colored toner particles to the vinyl resin included in the colored toner satisfies 0≤W-C≤4.

7. The electrostatic-image developing toner set according to claim 1,
wherein a Net intensity of a sulfur element included in the colored toner particles, the Net intensity being determined by X-ray fluorescence spectrometry, is 3.0 kcps or more and 6.0 kcps or less.

8. The electrostatic-image developing toner set according to claim 7,
wherein the Net intensity of the sulfur element included in the colored toner particles, the Net intensity being determined by X-ray fluorescence spectrometry, is 3.8 kcps or more and 5.7 kcps or less.

9. The electrostatic-image developing toner set according to claim 1,
wherein, when the cross section of the colored toner particles is observed, an area fraction of the polyester resin present in an inside region of the colored toner particles, the inside region being closer to the center than the surface layer region of the colored toner particles, is 15% or more and 45% or less.

10. The electrostatic-image developing toner set according to claim 1,
wherein, when the cross section of the colored toner particles is observed, a ratio X (perimeter/equivalent-circle perimeter) of a perimeter of the colored toner particles to an equivalent-circle perimeter of the colored toner particles is 1.14 or less.

11. An electrostatic-image developer set comprising:
a white electrostatic-image developer including the white toner included in the electrostatic-image developing toner set according to claim 1; and
a colored electrostatic-image developer including the colored toner included in the electrostatic-image developing toner set according to claim 1.

12. An electrostatic-image developer set comprising:
a white electrostatic-image developer including the white toner included in the electrostatic-image developing toner set according to claim 2; and
a colored electrostatic-image developer including the colored toner included in the electrostatic-image developing toner set according to claim 2.

13. An electrostatic-image developer set comprising:
a white electrostatic-image developer including the white toner included in the electrostatic-image developing toner set according to claim 3; and
a colored electrostatic-image developer including the colored toner included in the electrostatic-image developing toner set according to claim 3.

14. An electrostatic-image developer set comprising:
a white electrostatic-image developer including the white toner included in the electrostatic-image developing toner set according to claim 4; and
a colored electrostatic-image developer including the colored toner included in the electrostatic-image developing toner set according to claim 4.

15. An electrostatic-image developer set comprising:
a white electrostatic-image developer including the white toner included in the electrostatic-image developing toner set according to claim 5; and
a colored electrostatic-image developer including the colored toner included in the electrostatic-image developing toner set according to claim 5.

16. An electrostatic-image developer set comprising:
a white electrostatic-image developer including the white toner included in the electrostatic-image developing toner set according to claim 6; and
a colored electrostatic-image developer including the colored toner included in the electrostatic-image developing toner set according to claim 6.

17. A toner cartridge set comprising:
a white toner cartridge detachably attachable to an image forming apparatus, the white toner cartridge including the white toner included in the electrostatic-image developing toner set according to claim 1; and
a colored toner cartridge detachably attachable to an image forming apparatus, the colored toner cartridge including the colored toner included in the electrostatic-image developing toner set according to claim 1.

18. A process cartridge detachably attachable to an image forming apparatus, the process cartridge comprising:
a first developing unit including the white electrostatic-image developer included in the electrostatic-image developer set according to claim 11; and
a second developing unit including the colored electrostatic-image developer included in the electrostatic-image developer set according to claim 11.

19. An image forming apparatus comprising:
a first image formation unit including a first developing unit including the white electrostatic-image developer included in the electrostatic-image developer set according to claim 11, the first image formation unit being capable of forming a white image with the white toner;
a second image formation unit including a second developing unit including the colored electrostatic-image developer included in the electrostatic-image developer set according to claim 11, the second image formation unit being capable of forming a colored image with the colored toner;
a transfer unit that transfers the white and colored images onto a surface of a recording medium; and
a fixing unit that fixes the white and colored images transferred on the surface of the recording medium.

20. An image forming method comprising:
forming a white image with the white toner included in the electrostatic-image developing toner set according to claim 1;
forming a colored image with the colored toner included in the electrostatic-image developing toner set according to claim 1;
transferring the white and colored images onto a surface of a recording medium; and
fixing the white and colored images transferred on the surface of the recording medium.
